(19) United States
(12) Patent Application Publication
(10) Pub. No.: US 2025/0103052 A1
(43) Pub. Date: Mar. 27, 2025

(54) DYNAMIC PERFORMANCE OF ACTIONS BY A MOBILE ROBOT BASED ON SENSOR DATA AND A SITE MODEL

(71) Applicant: Boston Dynamics, Inc., Waltham, MA (US)

(72) Inventors: Matthew Jacob Klingensmith, Somerville, MA (US); Michael James McDonald, Cambridge, MA (US); Radhika Agrawal, Waltham, MA (US); Christopher Peter Allum, Lexington, MA (US); Rosalind Fish Blais Shinkle, New York City, NY (US)

(21) Appl. No.: 18/613,943

(22) Filed: Mar. 22, 2024

Related U.S. Application Data
(60) Provisional application No. 63/585,368, filed on Sep. 26, 2023.

(51) Int. Cl. G05D 1/246; G05D 109/12; G06F 40/30; G10L 15/22

(52) U.S. Cl. CPC G05D 1/246; G06F 40/30; G10L 15/22; G05D 2109/12; G10L 2015/223

(57) ABSTRACT

Systems and methods are described for instructing performance of an action by a mobile robot based on transformed data. A system may obtain a site model in a first data format and sensor data in a second data format. The site model and/or the sensor data may be annotated. The system may transform the site model and the sensor data to generate transformed data in a third data format. The system may provide the transformed data to a computing system. For example, the system may provide the transformed data to a machine learning model. Based on the output of the computing system, the system may identify an action and instruct performance of the action by a mobile robot.

### CROSS REFERENCE TO RELATED APPLICATION

This U.S. patent application claims priority under 35 U.S.C. § 119 (c) to U.S. Provisional Application No. 63/585,368, filed Sep. 26, 2023, which is considered part of the disclosure of this application and is hereby incorporated by reference in its entirety.

### TECHNICAL FIELD

This disclosure relates generally to robotics, and more specifically, to systems, methods, and apparatuses, including computer programs, for dynamic performance of actions by a mobile robot.

### BACKGROUND

Robotic devices can autonomously or semi-autonomously navigate sites (e.g., environments) to perform a variety of tasks or functions. The robotic devices can utilize sensor data to navigate the sites without contacting obstacles or becoming stuck or trapped. As robotic devices become more prevalent, there is a need to enable the robotic devices to perform actions in a specific manner as the robot navigates the sites. For example, there is a need to enable the robotic devices to perform actions, in a safe and reliable manner, based on a site in which the robotic devices are operating.

### SUMMARY

An aspect of the present disclosure provides a method may include obtaining, by data processing hardware of a mobile robot, a site model associated with a site and in a first data format. The method may further include obtaining, by the data processing hardware, sensor data in a second data format. The method may further include transforming, by the data processing hardware, the site model from the first data format to a text data format to obtain a transformed site model. The method may further include transforming, by the data processing hardware, the sensor data from the second data format to the text data format to obtain transformed sensor data. The method may further include obtaining, by the data processing hardware, transformed data in the text data format based on the transformed site model and the transformed sensor data. The method may further include providing, by the data processing hardware, the transformed data to a computing system. The method may further include identifying, by the data processing hardware, an action based on an output of the computing system in response to providing the transformed data to the computing system. The method may further include instructing, by the data processing hardware, performance of the action by the mobile robot.

In various embodiments, the method may further include obtaining prompt data according to a programming language. The method may further include providing the prompt data to the computing system. The output of the computing system may be based on the prompt data. Transforming the site model and the sensor data may include generating the transformed data. The transformed data may include one or more semantic tokens according to the processing language. The output of the computing system may be based on the one or more semantic tokens and the one or more comments.

In various embodiments, the method may further include obtaining prompt data. The prompt data may include one or more comments according to a programming language. The method may further include providing the prompt data to the computing system. The output of the computing system may be based on the prompt data. Transforming the site model and the sensor data may include generating the transformed data. The transformed data may include one or more first semantic tokens according to the processing language. The output of the computing system may be based on the one or more first semantic tokens, the one or more comments, and one or more second semantic tokens.

In various embodiments, transforming the site model and the sensor data may include generating the transformed data according to a programming language.

In various embodiments, transforming the site model and the sensor data may include generating the transformed data according to one or more of a syntax of a programming language or semantics of a processing language.

In various embodiments, transforming the site model and the sensor data may include generating the transformed data. The transformed data may include one or more semantic tokens according to a processing language.

In various embodiments, transforming the site model and the sensor data may include generating the transformed data. The transformed data may include one or more semantic tokens according to a processing language. The one or more semantic tokens may include one or more operators based on a library associated with the processing language.

In various embodiments, transforming the site model and the sensor data may include generating the transformed data. The transformed data may include one or more semantic tokens according to a processing language. The one or more semantic tokens may include one or more functions based on a library associated with the processing language.

In various embodiments, transforming the site model and the sensor data may include generating the transformed data. The transformed data may include one or more semantic tokens according to a processing language. The one or more semantic tokens may include one or more keywords based on a library associated with the processing language.

In various embodiments, transforming the site model and the sensor data may include generating the transformed data according to a Python programming language.

In various embodiments, the first data format may include a first image data format. The second data format may include a second image data format.

In various embodiments, the first data format and the second data format may be different data formats.

In various embodiments, the action may be based on prompt data.

In various embodiments, the method may further include obtaining prompt data. The method may further include providing the prompt data to the computing system. The output of the computing system may be based on the prompt data.

In various embodiments, the method may further include obtaining prompt data according to a programming language. The method may further include providing the prompt data to the computing system. The output of the computing system may be based on the prompt data.

In various embodiments, the method may further include obtaining prompt data according to a programming language. The method may further include providing the prompt data to the computing system. The output of the computing system may be based on the prompt data. Transforming the site model and the sensor data may include generating the transformed data. The transformed data may include one or more semantic tokens according to the processing language.

In various embodiments, the method may further include obtaining prompt data. The prompt data may include one or more comments according to a programming language. The method may further include providing the prompt data to the computing system. The output of the computing system may be based on the prompt data. Transforming the site model and the sensor data may include generating the transformed data. The transformed data may include one or more semantic tokens according to the processing language.

In various embodiments, the method may further include obtaining prompt data. The prompt data may include one or more comments according to a programming language. The method may further include providing the prompt data to the computing system. The output of the computing system may be based on the prompt data. Transforming the site model and the sensor data may include generating the transformed data. The transformed data may include one or more first semantic tokens according to the processing language. The computing system may process the one or more first semantic tokens and the one or more comments to generate one or more second semantic tokens. The output may be based on the one or more second semantic tokens.

In various embodiments, the method may further include obtaining prompt data. The prompt data may include one or more comments according to a programming language. The method may further include providing the prompt data to the computing system. The output of the computing system may be based on the prompt data. Transforming the site model and the sensor data may include generating the transformed data. The transformed data may include one or more first semantic tokens according to the processing language. The computing system may process the one or more first semantic tokens and the one or more comments to generate one or more second semantic tokens. The computing system may convert the one or more second semantic tokens into the action.

In various embodiments, the method may further include identifying a persona of the mobile robot. The action may be based on the persona of the mobile robot.

In various embodiments, the method may further include identifying a persona of the mobile robot. The action may be based on the persona of the mobile robot. The persona of the mobile robot may include an energetic persona, an upbeat persona, a happy persona, a professional persona, a disinterested persona, a quiet persona, a boisterous persona, an aggressive persona, a competitive persona, an achievement-oriented persona, a stressed persona, a counseling persona, an investigative persona, a social persona, a realistic persona, an artistic persona, a conversational persona, an enterprising persona, an enthusiastic persona, an excited persona, or a snarky persona.

In various embodiments, the method may further include identifying a persona of the mobile robot. The action may be based on the persona of the mobile robot. The persona of the mobile robot may include a time period based persona, a location based persona, an entity based persona, or an emotion based persona.

In various embodiments, the method may further include instructing display of a user interface. The user interface may provide a plurality of personas of the mobile robot for selection. The method may further include obtaining a selection of a persona of the mobile robot of the plurality of personas of the mobile robot. The action may be based on the persona of the mobile robot.

In various embodiments, the method may further include obtaining an output of a machine learning model. The method may further include identifying a persona of the mobile robot based on the output of the machine learning model. The action may be based on the persona of the mobile robot.

In various embodiments, the method may further include identifying a persona of the mobile robot. The action may be based on the persona of the mobile robot. The persona of the mobile robot may be indicative of at least one of a character description, a character goal, or a character phrase.

In various embodiments, the method may further include obtaining second sensor data. The method may further include identifying a persona of the mobile robot based on the second sensor data. The action may be based on the persona of the mobile robot.

In various embodiments, the method may further include obtaining audio data. The method may further include providing the audio data to a second computing system. The method may further include obtaining transformed audio data based on providing the audio data to the second computing system. The method may further include identifying a portion of the transformed audio data corresponds to a particular phrase. Transforming the site model and the sensor data may include transforming the site model and the sensor data based on identifying the portion of the transformed audio data corresponds to the particular phrase.

In various embodiments, the method may further include obtaining audio data. The method may further include providing the audio data to a second computing system. The method may further include obtaining transformed audio data based on providing the audio data to the second computing system. The method may further include identifying a portion of the transformed audio data corresponds to a particular phrase. The method may further include instructing performance of one or more actions by the mobile robot to be paused based on identifying the portion of the transformed audio data corresponds to the particular phrase.

In various embodiments, the method may further include obtaining audio data. The method may further include providing the audio data to a second computing system. The method may further include obtaining transformed audio data based on providing the audio data to the second computing system. The method may further include identifying a portion of the transformed audio data corresponds to a wake word or a wake phrase. Obtaining the sensor data may include obtaining the sensor data in response to identifying the portion of the transformed audio data corresponds to the wake word or the wake phrase.

In various embodiments, the method may further include obtaining first audio data. The method may further include identifying second audio output by the mobile robot. The method may further include suppressing the second audio output by the mobile robot based on the first audio data.

In various embodiments, the method may further include pausing movement of the mobile robot. The method may further include obtaining audio data based on pausing movement of the mobile robot.

In various embodiments, the action may be indicative of at least one of audio data or a movement of the mobile robot.

In various embodiments, the action may be indicative of at least one of audio data or a movement of the mobile robot. Instructing performance of the action may include instructing output of the audio data by the mobile robot.

In various embodiments, the action may be indicative of at least one of audio data or a movement of the mobile robot. Instructing performance of the action may include instructing output of the audio data by the mobile robot. Instructing output of the audio data may include instructing output of the audio data via a speaker of the mobile robot.

In various embodiments, the action may be indicative of at least one of audio data or a movement of the mobile robot. Instructing performance of the action may include instructing output of the audio data by the mobile robot. Instructing output of the audio data may include instructing output of the audio data via a speaker of the mobile robot. The audio data may include a question or a phrase.

In various embodiments, the method may further include obtaining audio data. The method may further include assigning an identifier to an entity based on the audio data.

In various embodiments, the action may be indicative of at least one of audio data or a movement of the mobile robot. Instructing performance of the action may include assigning an identifier to an entity within an environment of the mobile robot. The audio data may be based on the entity. Instructing performance of the action may further include instructing output of the audio data by the mobile robot.

In various embodiments, the action may be indicative of at least one of audio data or a movement of the mobile robot. Instructing performance of the action may include determining an entity within an environment of the mobile robot. The audio data may be based on the entity. Instructing performance of the action may further include instructing output of the audio data by the mobile robot.

In various embodiments, the action may be indicative of audio data and a movement of the mobile robot. Instructing performance of the action may include determining an entity within an environment of the mobile robot. The audio data may be based on the entity. Instructing performance of the action may further include instructing performance of the movement by the mobile robot such that the mobile robot is oriented in a direction towards the entity. Instructing performance of the action may further include instructing output of the audio data by the mobile robot.

In various embodiments, the action may be indicative of audio data and a movement of the mobile robot. Instructing performance of the action may include determining an entity within an environment of the mobile robot. The audio data may be based on the entity. Instructing performance of the action may further include instructing simultaneous performance of the movement and output of the audio data by the mobile robot.

In various embodiments, the action may be indicative of at least one of audio data or a movement of the mobile robot. Instructing performance of the action may include instructing performance of the movement by the mobile robot.

In various embodiments, the action may be indicative of at least one of audio data or a movement of the mobile robot. Instructing performance of the action may include instructing performance of the movement by the mobile robot. Instructing performance of the movement may include instructing the mobile robot to move according to the movement.

In various embodiments, the action may be indicative of at least one of audio data or a movement of the mobile robot. Instructing performance of the action may include instructing performance of the movement by the mobile robot. Instructing performance of the movement may include instructing at least one of a leg of the mobile robot or an arm of the mobile robot to move according to the movement.

In various embodiments, the method may further include determining a second action performed by the mobile robot based on instructing performance of the action. The method may further include identifying a third action based on providing second transformed data, an identifier of the second action, the sensor data, and the site model to the computing system. The method may further include instructing performance of the third action by the mobile robot.

In various embodiments, the method may further include determining a result of instructing performance of the action. The method may further include obtaining a second site model associated with a second site and in the first data format. The method may further include obtaining second sensor data in the second data format. The method may further include transforming the second site model and the second sensor data to generate second transformed data in the text data format. The method may further include providing the second transformed data and the result of instructing performance of the action to the computing system. The method may further include identifying a second action based on a second output of the computing system in response to providing the transformed data and the result of instructing performance of the action to the computing system. The method may further include instructing performance of the second action by the mobile robot.

In various embodiments, the method may further include determining a result of instructing performance of the action. The method may further include obtaining a second site model associated with a second site and in the first data format. The method may further include obtaining second sensor data in the second data format. The method may further include transforming the second site model and the second sensor data to generate second transformed data in the text data format. The method may further include providing the second transformed data, prompt data indicative of the action, and the result of instructing performance of the action to the computing system. The method may further include identifying a second action based on a second output of the computing system in response to providing the transformed data, the prompt data, and the result of instructing performance of the action to the computing system. The method may further include instructing performance of the second action by the mobile robot.

In various embodiments, the method may further include determining a result of instructing performance of the action. A machine learning model of the computing system may be trained based on the result of instructing performance of the action.

In various embodiments, providing the transformed data to the computing system may include providing the transformed data to a machine learning model.

In various embodiments, providing the transformed data to the computing system may include providing the transformed data to a machine learning model. The machine learning model may be implemented by the data processing hardware.

In various embodiments, providing the transformed data to the computing system may include providing the transformed data to a machine learning model. The machine learning model may be implemented by a remote computing system.

In various embodiments, the method may further include obtaining, from the computing system, the output of the computing system.

In various embodiments, obtaining the sensor data may include obtaining the sensor data from a first data source. Obtaining the site model may include obtaining the site model from a second data source.

In various embodiments, obtaining the sensor data may include obtaining the sensor data from a sensor of the mobile robot. Obtaining the site model may include obtaining the site model from a computing system located remotely from the mobile robot.

In various embodiments, the site model may include an annotated site model.

In various embodiments, the site model may include an annotated site model. The annotated site model may include one or more semantic labels associated with one or more objects in the site.

In various embodiments, the method may further include providing the site model for annotation. The method may further include obtaining an annotated site model based on providing the site model for annotation. Transforming the site model and the sensor data may include transforming the annotated site model and the sensor data.

In various embodiments, the method may further include providing, to a machine learning model, the site model for annotation. The method may further include obtaining, from the machine learning model, an annotated site model based on providing the site model for annotation. Transforming the site model and the sensor data may include transforming the annotated site model and the sensor data.

In various embodiments, the site model may include one or more of site data, map data, blueprint data, environment data, model data, or graph data.

In various embodiments, the site model may include a virtual representation of one or more of a blueprint, a map, a computer-aided design (“CAD”) model, a floor plan, a facilities representation, a geo-spatial map, or a graph.

In various embodiments, at least one of the sensor data or the site model may be captured based on movement of the mobile robot along a route through the site.

In various embodiments, the sensor data may include audio data or image data.

In various embodiments, the sensor data may be captured by one or more sensors of the mobile robot.

In various embodiments, the sensor data may be captured by one or more sensors of the mobile robot. The one or more sensors may include a stereo camera, scanning light-detection and ranging sensor, or a scanning laser-detection and ranging sensor.

In various embodiments, at least a first portion of the sensor data may be captured by one or more sensors of the mobile robot. At least a second portion of the sensor data may be captured by one or more sensors of a second mobile robot.

In various embodiments, the sensor data may include orientation data, image data, point cloud data, position data, and/or time data.

In various embodiments, the sensor data may include annotated sensor data. The annotated sensor data may include one or more captions associated with the sensor data.

In various embodiments, the method may further include providing the sensor data for annotation. The method may further include obtaining annotated sensor data based on providing the sensor data for annotation. Transforming the site model and the sensor data may include transforming the site model and the annotated sensor data.

In various embodiments, the method may further include providing, to a machine learning model, the sensor data for annotation. The method may further include obtaining, from the machine learning model, annotated sensor data based on providing the sensor data for annotation. Transforming the site model and the sensor data may include transforming the site model and the annotated sensor data.

In various embodiments, the method may further include obtaining an action identifier for the mobile robot. The action may be based on the action identifier.

In various embodiments, the method may further include instructing display of a user interface. The user interface may provide a plurality of action identifiers of the mobile robot for selection. The method may further include obtaining a selection of an action identifier of the plurality of action identifiers. The action may be based on the action identifier.

In various embodiments, the method may further include obtaining an action identifier for the mobile robot. The action may be based on the action identifier. The action may include a guide action to guide an entity through the site.

In various embodiments, the method may further include collating the transformed site model and the transformed sensor data to generate the transformed data.

In various embodiments, the action may be based on the transformed data.

In various embodiments, the action may include a navigation action and/or an audio based action.

In various embodiments, the mobile robot may be a legged robot.

According to various embodiments of the present disclosure, a method may include obtaining, by data processing hardware of a mobile robot, an input indicative of an action for the mobile robot. The method may further include identifying, by the data processing hardware, one or more movements for an arm of the mobile robot based on the input. The method may further include identifying, by the data processing hardware, audio data based on the input. The method may further include synchronizing the audio data to the one or more movements to obtain synchronized audio data and one or more synchronized movements. The method may further include instructing, by the data processing hardware, performance of the one or more synchronized movements by the mobile robot. The method may further include instructing, by the data processing hardware, output of the synchronized audio data by the mobile robot.

According to various embodiments of the present disclosure, a method may include identifying, by data processing hardware of a mobile robot, audio data based on first sensor data associated with the mobile robot. The method may further include obtaining, by the data processing hardware, second sensor data associated with the mobile robot. The method may further include identifying, by the data processing hardware, an entity located within an environment of the mobile robot based on the second sensor data. The method may further include instructing, by the data processing hardware, movement of an arm of the mobile robot such that the arm is oriented in a direction towards the entity. The method may further include instructing, by the data processing hardware, output of the audio data based on instructing movement of the arm.

According to various embodiments of the present disclosure, a method may include identifying, by data processing hardware of a mobile robot, a first input indicative of a first persona of the mobile robot. The method may further include instructing, by the data processing hardware, performance of one or more first actions of the mobile robot by the mobile robot in accordance with the first persona of the mobile robot. The method may further include identifying, by the data processing hardware, a second input indicative of a second persona of the mobile robot that is different from the first persona of the mobile robot. The method may further include instructing, by the data processing hardware, performance of one or more second actions of the mobile robot by the mobile robot in accordance with the second persona of the mobile robot.

In various embodiments, the first persona may be associated with a first set of audio characteristics. The second persona may be associated with a second set of audio characteristics.

In various embodiments, the first persona may be associated with one or more of a first pitch, a first accent, a first pace, a first volume, a first rate, a first rhythm, a first articulation, a first pronunciation, a first annunciation, a first tone, a first background, a first language, a first gender, or a first fluency. The second persona may be associated with one or more of a second pitch, a second accent, a second pace, a second volume, a second rate, a second rhythm, a second articulation, a second pronunciation, a second annunciation, a second tone, a second background, a second language, a second gender, or a second fluency.

According to various embodiments of the present disclosure, a method may include obtaining, by data processing hardware of a mobile robot, sensor data associated with an environment of the mobile robot. The method may further include identifying, by the data processing hardware, an entity located within the environment of the mobile robot based on the sensor data. The method may further include assigning, by the data processing hardware, an entity identifier to the entity. The method may further include determining, by the data processing hardware, one or more communication parameters based on the entity identifier. The method may further include instructing, by the data processing hardware, output of audio data according to the one or more communication parameters.

According to various embodiments of the present disclosure, a system may include data processing hardware and memory in communication with the data processing hardware. The memory may store instructions that when executed on the data processing hardware cause the data processing hardware to obtain a site model associated with a site and in a first data format. Execution of the instruction may further cause the data processing hardware to obtain, by at least one sensor, sensor data in a second data format. Execution of the instruction may further cause the data processing hardware to transform the site model from the first data format to a text data format to obtain a transformed site model. Execution of the instruction may further cause the data processing hardware to transform the sensor data from the second data format to the text data format to obtain transformed sensor data. Execution of the instruction may further cause the data processing hardware to obtain transformed data in the text data format based on the transformed site model and the transformed sensor data. Execution of the instruction may further cause the data processing hardware to provide the transformed data to a computing system. Execution of the instruction may further cause the data processing hardware to identify an action based on an output of the computing system in response to providing the transformed data to the computing system. Execution of the instruction may further cause the data processing hardware to instruct performance of the action by a mobile robot.

In various embodiments, the system may include any combination of the aforementioned features.

According to various embodiments of the present disclosure, a robot may include at least one sensor, at least two legs, data processing hardware in communication with the at least one sensor, memory in communication with the data processing hardware The memory may store instructions that when executed on the data processing hardware cause the data processing hardware to obtain a site model associated with a site and in a first data format. Execution of the instruction may further cause the data processing hardware to obtain, by the at least one sensor, sensor data in a second data format. Execution of the instruction may further cause the data processing hardware to transform the site model from the first data format to a text data format to obtain a transformed site model. Execution of the instruction may further cause the data processing hardware to transform the sensor data from the second data format to the text data format to obtain transformed sensor data. Execution of the instruction may further cause the data processing hardware to obtain transformed data in the text data format based on the transformed site model and the transformed sensor data. Execution of the instruction may further cause the data processing hardware to provide the transformed data to a computing system. Execution of the instruction may further cause the data processing hardware to identify an action based on an output of the computing system in response to providing the transformed data to the computing system. Execution of the instruction may further cause the data processing hardware to instruct performance of the action by the robot.

In various embodiments, the robot may include any combination of the aforementioned features.

The details of the one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example robot for navigating a site.

FIG. 1B is a schematic view of a navigation system for navigating the robot of FIG. 1A.

FIG. 2 is a schematic view of exemplary components of the navigation system.

FIG. 3 is a schematic view of a topological map.

FIG. 4 is a schematic view of a plurality of systems of the robot of FIG. 1A.

FIG. 5A is a schematic view of a site model.

FIG. 5B is a schematic view of an annotated site model.

FIG. 6A is a schematic view of a robot navigating in a site with an entity and an object.

FIG. 6B is a schematic view of sensor data associated with a site with an entity and an object.

FIG. 6C is a schematic view of annotated sensor data associated with a site with an entity and an object.

FIG. 6D is a schematic view of annotated sensor data associated with a site with an entity and an object.

FIG. 7 is a schematic view of a route of a robot and point cloud data.

FIG. 8A is a schematic view of an example robot implementing an example action based on transformed data.

FIG. 8B is a schematic view of an example robot implementing an example action based on transformed data.

FIG. 9 is a flowchart of an example arrangement of operations for instructing performance of an action by a mobile robot.

FIG. 10 is a schematic view of an example computing device that may be used to implement the systems and methods described herein.

Like reference symbols in the various drawings indicate like elements.

### DETAILED DESCRIPTION

Generally described, autonomous and semi-autonomous robots can utilize mapping, localization, and navigation systems to map a site utilizing sensor data obtained by the robots. The robots can obtain data associated with the robot from one or more components of the robots (e.g., sensors, sources, outputs, etc.). For example, the robots can receive sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, and/or any other component of the robot. Further, the sensor data may include image data, lidar data, ladar data, radar data, pressure data, acceleration data, battery data (e.g., voltage data), speed data, position data, orientation data, pose data, tilt data, etc.

The robots can utilize the mapping, localization, and navigation systems and the sensor data to perform mapping, localization, and/or navigation in the site and build navigation graphs that identify route data. During the mapping, localization, and/or navigation, the robots may identify an output based on identified features representing entities, objects, obstacles, or structures within the site.

The present disclosure relates to dynamic identification and performance of an action (e.g., a job, a task, an operation, etc.) of a robot within the site in an interactive manner based on the sensor data. A computing system can identify the action based on multimodal sensing data. For example, the multimodal sensing data may be transformed sensor data (e.g., transformed point cloud data) and a transformed site model (e.g., transformed image data) of a site such that the computing system (and the action) are grounded on the transformed sensor data and the transformed site model. The computing system may provide the transformed sensor data and the transformed site model to a second computing system, to a component of the computing system, etc. and based on the output of the second computing system, the component, etc., the computing system may identify the action for performance.

The computing system may further identify the action based on prompt data (e.g., indicating a persona of the robot, an action identifier for the robot, an entity identifier for an entity located at the site, a request, command, instruction, etc. to determine an action, etc.) such that the computing system identifies different actions based on different prompt data (e.g., output audio data as compared to move to a location) and/or different manners of performing the same action based on different prompt data (e.g., a first pitch for outputting audio based on text data as compared to a second pitch for outputting audio based on the text data).

In some cases, the prompt data may be and/or may include a prompt. For example, the prompt (or the prompt data) may be and/or may include a state prompt, a system prompt, etc. In some cases, the computing system may identify a prompt based on the prompt data, the transformed sensor data, and/or the transformed site model (e.g., the prompt may be and/or may include the prompt data, the transformed sensor data, and/or the transformed site model). For example, the computing system may dynamically generate a prompt based on the prompt data, the transformed sensor data, and the transformed site model. In some cases, the prompt data may include the transformed sensor data and/or the transformed site model.

The computing system can identify sensor data associated with the site (e.g., sensor data associated with traversal of the site by a robot). For example, the system can communicate with a sensor of a robot and obtain sensor data associated with a site of the robot via the sensor as the robot traverses the site.

The computing system can identify the site model (e.g., two-dimensional image data, three-dimensional image data, text data, etc.) associated with the site of the robot. For example, the site model may include a floorplan, a blueprint, a computer-aided design (“CAD”) model, a map, a graph, a drawing, a layout, a figure, an architectural plan, a site plan, a diagram, an outline, a facilities representation, a geo-spatial rendering, a building information model, etc. In some cases, the site model may be an identification (e.g., a listing, a list, a directory, etc.) of spaces associated with a site (e.g., areas, portions of the site, chambers, rooms) and/or identifiers (e.g., descriptors) of the spaces (e.g., “break room,” “restroom,” “museum,” “docking station,” etc.). For example, the site model may be and/or may include text data indicating one or more spaces and one or more identifiers of the one or more spaces.

The sensor data and the site model may identify features of the site (e.g., obstacles, objects, and/or structures). For example, the features may include one or more spaces of the site (e.g., rooms, hallways, zones, sections, enclosed areas, unenclosed areas, etc.), structures of the site (e.g., walls, stairs, etc.), entities (e.g., persons, robots, etc.), objects (e.g., vehicles, docking stations, etc.), and/or obstacles (e.g., toys, pallets, rocks, etc.) that may affect the movement of the robot as the robot traverses the site. It will be understood that while persons or humans may be referenced to herein, these terms are used interchangeably. The features may include static objects, entities, structures, or obstacles (e.g., objects, entities, structures, or obstacles that are not capable of self-movement) and/or dynamic objects, entities, structures, or obstacles (e.g., objects, entities, structures, or obstacles that are capable of self-movement). Further, the objects, entities, structures, or obstacles may include objects, entities, structures, or obstacles that are integrated into the site (e.g., the walls, stairs, the ceiling, etc.) and objects, entities, structures, or obstacles that are not integrated into the site (e.g., a ball on the floor or on a stair).

The sensor data and the site model may identify the features of the site in different manners. For example, the sensor data may indicate the presence of a feature based on the absence of sensor data and/or a grouping of sensor data while the site model may indicate the presence of a feature based on one or more pixels having a particular pixel value or pixel characteristic (e.g., color) and/or a group of pixels having a particular shape or set of characteristics.

The sensor data and the site model may be annotated with one or more annotations (e.g., semantic labels, labels, tags, markers, designations, descriptions, characterizations, identifications, titles, captions, semantic tokens, etc.). For example, the sensor data and the site model may be annotated with one or more semantic labels. While semantic labels may be referred to herein, it will be understood that any annotations may be utilized.

The one or more semantic labels may be labels for one or more features of the site of the robot. In some cases, the one or more semantic labels may include a hierarchical plurality of labels. For example, the one or more semantic labels may include a first label indicating that an area within the site is a hallway, a second label indicating that a portion of the hallway is a trophy case, a third label indicating that a section of the trophy case includes trophies from 2000 to 2010, a fourth label indicating that a trophy of the trophies from 2000 to 2010 is a Best In Place Trophy from 2001, etc.

As each of the sensor data and the site model may provide information about the site (e.g., different information, information in different data formats, information with different data types, information with different processing statuses, information with different amounts or levels of detail, information from different data sources, etc.), the computing system can utilize both the sensor data and the site model to identify an action for performance by the robot. The computing system can transform (e.g., normalize) the sensor data and the site model and identify the action for performance by the robot using the transformed sensor data and the transformed site model.

In traditional systems (e.g., traditional static obstacle avoidance systems), while a robot may be programmed to identify features (e.g., the robot may identify features representing a corner, an obstacle, etc. within a site) and avoid objects, entities, structures, and/or obstacles representing or corresponding to the features (e.g., to avoid obstacles corresponding to the features) based on sensor data, the traditional systems may not dynamically perform customized actions according to prompt data. For example, the traditional systems may not perform customized actions based on a persona of the robot identified based on prompt data. Instead, traditional systems may perform the same action based on sensor data without regard to prompt data.

Further, the traditional systems may not cause the robot to dynamically implement particular actions based on sensor data and a site model. For example, the traditional systems may not cause the robot to implement a site model-based action, let alone a site model and sensor data-based action. Instead, while the traditional systems may cause display of the site model via a user computing device (e.g., to provide a virtual representation of the site of the robot), the traditional systems may not identify and/or implement actions based on the site model. Therefore, the traditional systems may not dynamically implement an action that is based on sensor data and a site model indicative of a feature in a site of a robot.

In some cases, a site model and sensor data may include conflicting information. For example, the site model may indicate that a first room is a library and the sensor data may indicate that the first room is a restroom. In traditional systems, the systems may implement an action based on the indication of the sensor data (e.g., that the first room is a restroom) and without regard to the indication of the site model (e.g., that the first room is a library). Therefore, the systems may implement actions that are inconsistent with the site model. For example, the systems may instruct the robot to implement an action based on the sensor data indicating the presence of a first feature, however, the site may include a different feature and/or may not include the first feature. Such an inconsistency may cause issues and/or inefficiencies (e.g., computational inefficiencies) as instructions may be generated and provided to the robot based on the sensor data which may be erroneous as compared to the site model. Further, such an inconsistency may cause a loss of confidence in the sensor data, the site model, the systems, and/or the robot.

In some cases, a first portion of the sensor data may match the site model and a second portion of the sensor data may not match the site model. For example, the site model may be annotated with a first semantic label for a particular room (e.g., a museum) and a second semantic label for a portion of the room (e.g., an ancestry exhibit) and the sensor data may be annotated with the first semantic label for the room and a third semantic label for the portion of the room (e.g., a welcome desk). Further, the site may be renovated (e.g., updated, revised, etc.) and one or more of the site model, the annotations of the site model, the annotations of the sensor data, etc. may not reflect the renovated site. For example, an object, entity, structure, or obstacle (e.g., an exhibit) may move from a first location in a first room of the site to a second location in the first room of the site subsequent to the generation of the site model and prior to the generation of the sensor data. In another example, a room may be repurposed (e.g., from a conference room to a staging room) subsequent to the generation of the site model and prior to the generation of the sensor data. In such cases, the site model and the sensor data may reflect the same rooms within the site, but may reflect different features within the rooms, different labels for the rooms, etc.

In some cases, a user may attempt to manually provide instructions to perform an action. For example, a system of a robot may receive input from a user computing device indicating an action for performance by the robot (e.g., walk forward, extend an arm, etc.). However, such an action identification may cause issues and/or inefficiencies (e.g., movement inefficiencies) as the input may be based on an erroneous interpretation of the site (e.g., by the user). Further, such an action identification may be resource and time intensive and inefficient as the number of actions performed by the robot may be large.

The methods and apparatus described herein enable a system to transform sensor data (which can include route data) and a site model (e.g., into a particular data format) and instruct performance of an action based on the transformed data. The system can automatically transform the data (e.g., in response to received sensor data and/or a site model).

As components (e.g., mobile robots) proliferate, the demand for dynamic performance of actions by the components has increased. Specifically, the demand for robots to dynamically perform actions based on sensor data and a site model (e.g., semantic labels of the sensor data and the site model) has increased. For example, a site may include one or more entities, objects, obstacles, or structures such that the sensor data and/or the site model is indicative of and/or reflects the one or more entities, objects, obstacles, or structures. Further, a user may attempt to direct a robot to perform an action within the site. The present disclosure provides systems and methods that enable an increase in the accuracy and efficiency of the performance of the action and an increase in the overall efficiency of the robot.

Further, the present disclosure provides systems and methods that enable a reduction in the time and user interactions, relative to traditional embodiments, to perform actions based on the sensor data and/or the site model without significantly affecting the power consumption or speed of the robot. These advantages are provided by the embodiments discussed herein, and specifically by implementation of a process that includes the transformation of the sensor data and the site model into a particular data format. By performing actions based on the sensor data and/or the site model, the robot can be grounded based on the site of the robot. For example, the robot may be grounded based on the sensor data associated with the site, the site model associated with the site, and the prompt data.

As described herein, the process of transforming the sensor data and the site model to perform one or more actions may include obtaining the sensor data and the site model. For example, a computing system can obtain sensor data via a sensor of the robot and obtain a site model from a user computing device.

The computing system (or a separate system) may process the sensor data and may determine a portion of the sensor data corresponds to particular sensor data. For example, the computing system may process audio data and may determine that a portion of the audio data corresponds to a wake word or wake phrase. Further, the wake word or wake phrase may be a word or phrase to instruct the computing system to 1) pause and/or interrupt performance of one or more actions of the robot and/or 2) capture sensor data using one or more sensors. For example, the wake word or wake phrase may be “pause,” “stop,” “hey spot,” “question,” “spot,” etc.

In response to determining the portion of the sensor data corresponds to particular sensor data, the computing system may instruct the robot to perform one or more actions. For example, the computing system may instruct the robot to identify an entity within the site based on sensor data and may instruct movement of the robot (e.g., an arm of the robot) such that the robot (e.g., the arm) is oriented in a direction towards (e.g., facing) the entity. Further, the computing system may instruct the robot to obtain sensor data and/or output sensor data. For example, the computing system may instruct the robot to obtain audio data via an audio sensor of the robot (e.g., indicative of audio instructions) and output audio data (e.g., requesting audio instructions).

In some cases, the computing system may instruct pausing of one or more second actions by the robot. For example, the robot may obtain audio data corresponding to a wake word or wake phrase while performing an action (e.g., turning a lever, navigating to a location, etc.) and/or while an action is scheduled to be performed, and, in response to determining that the audio data corresponds to the wake word or wake phrase, the computing system may instruct the robot to pause performance or delay scheduled performance of the action. For example, the computing system can interrupt actions currently being performed by the robot and/or scheduled to be performed by the robot.

Based on determining the sensor data corresponds to particular sensor data, the computing system may obtain sensor data, a site model, prompt data (e.g., an action identifier, an entity identifier, a persona, etc.), etc. to identify an action for performance. For example, the computing system may identify, from the prompt data, an action identifier indicative of an action for the robot to perform, an entity identifier indicative of an entity, and/or a persona of the robot. In some cases, the prompt data may be based on audio data obtained via the audio sensor of the robot (e.g., audio instructions).

In some cases, the computing system may identify the prompt data (e.g., which may be, may include, or may correspond to a state prompt, a system prompt, etc.). The prompt data may indicate a persona (e.g., a personality, a state, a behavior, a quality, a temperament, a character description, a character goal, a character phraseology, etc.) of the robot from a plurality of the personas. The prompt data may indicate a different persona based on a time, location, entity, emotion, etc. associated with the robot. For example, the persona may be an energetic persona, an upbeat persona, a happy persona, a professional persona, a disinterested persona, a quiet persona, a boisterous persona, an aggressive persona, a competitive persona, an achievement-oriented persona, a stressed persona, a counseling persona, an investigative persona, a social persona, a realistic persona, an artistic persona, a conversational persona, an enterprising persona, an enthusiastic persona, an excited persona, or a snarky persona. This in turn enables a number of applications involving mobile robots interacting with, guiding, and/or educating people, for example, application in which mobile robots serve as tour guides, teachers, entertainers, characters in physically-embodied games, characters in movies, characters in books, receptionists, and/or security guards.

The prompt data may further indicate an entity identifier indicative of an entity within the site. For example, the prompt data may indicate a particular entity is located in the site.

The prompt data may further indicate an action identifier. For example, the prompt data may indicate that the robot is to act as a tour guide and guide an entity through the site on a tour. For example, the computing system may identify a tour guide action for the robot based on audio data of the prompt data that is associated with the phrase: “Please take me on a guided tour of the museum.”

To identify the prompt data, the computing system may obtain the prompt data from a second computing system (e.g., the user computing device) and/or the computing system may generate the prompt data (e.g., using a machine learning model and based on sensor data and/or a site model).

To generate the prompt data, the computing system may provide data (e.g., the sensor data and/or the site model) to a machine learning model (e.g., a large language model, a visual question answering model, etc.). The machine learning model may output particular prompt data for the robot including one or more communication parameters (e.g., a persona) based on the provided data. For example, the machine learning model may output prompt data indicating an energetic persona based on the sensor data indicating kids are located in the site. In another example, the machine learning model may output prompt data indicating a tour guide persona based on the site model indicating that the site is a museum.

To obtain the prompt data from a second computing system, the computing system may identify all or a portion of the prompt data based on input received via the second computing system (e.g., the user computing device). For example, the computing system may cause display, via a user computing device, of a user interface indicating a plurality of personas, and the computing system may obtain input identifying a selection of a persona from the plurality of personas.

The prompt data may be customizable. For example, the user computing device may provide updated prompt data to customize the prompt data in real time (e.g., on demand). Further, the computing system may generate (e.g., dynamically) and adjust prompt data in real time. In one example, while the first prompt data may indicate that the robot is to perform actions according to a snarky persona, the computing system may obtain second prompt data indicating that the robot is to perform actions according to an excited persona. In response to obtaining the second prompt data, the computing system may pause and/or stop implementation of actions according to the first prompt data and may begin implementation of actions according to the second prompt data (e.g., in real time).

In some cases, the computing system may obtain annotated sensor data and/or an annotated site model. The annotated sensor data and/or the annotated site model may indicate labels for features of the site. For example, the annotated site model may indicate one portion of the site is labeled as a museum, another portion of the site is labeled as reception, another portion of the site is labeled as a break room, etc.

In some cases, the computing system may obtain unannotated sensor data and/or an unannotated site model. The computing system may annotate the unannotated sensor data and/or the unannotated site model (or annotate previously annotated sensor data and/or a previously annotated site model). For example, the computing system may annotate the sensor data and/or the site model using a machine learning model (e.g., trained to annotate sensor data and/or a site model). The machine learning model (e.g., implemented by the computing system) may be trained to annotate sensor data and/or a site model based on training data. For example, the machine learning model may be trained to respond to (e.g., answer) a question, command, or request associated with the sensor data and/or the site model (e.g., describe the sensor data). In some cases, the machine learning model may include a first machine learning model to annotate the sensor data and a second machine learning model to annotate the site model.

In some cases, the computing system may provide the sensor data and/or the site model to a second computing system for annotation. For example, the computing system may provide the sensor data and/or the site model to a second computing system (e.g., located separately or remote from the computing system) implementing a machine learning model (e.g., a large language model, a visual question answering model, etc.). The second computing system may utilize the machine learning model to generate a description of the sensor data and may generate annotated sensor data that includes the description (as an annotation) and the sensor data. The second computing system may be implementing a large language model such as Chat Generative Pre-trained Transformer (“ChatGPT”), Pathways Language Model (“PaLM”), Large Language Model Meta Artificial Intelligence (“LLaMA”), etc. In some cases, the second computing system may be a user computing device and the computing system may obtain the annotated sensor data and/or the annotated site model from the user computing device (e.g., based on user input). The computing system may obtain the annotated sensor data and/or the annotated site model from the second computing system.

In some cases, the sensor data and the site model may have different data formats, processing statuses, and/or data types. For example, the sensor data may be point cloud data and the site model may be image data. In another example, the sensor data may be raw image data (e.g., unprocessed image data) and the site model may be processed image data (e.g., a Joint Photographic Experts Group (“JPEG”) file).

In some cases, the sensor data and the site model may be captured via different data sources. For example, the sensor data may be captured via a first data source (e.g., a first image sensor) and the site model may be captured via a second data source (e.g., a second image sensor). Further, the sensor data may be captured via an image sensor located on the robot and the site model may be captured via an image sensor located remotely from the robot.

In some cases, the sensor data and the site model may reflect different locations. For example, the sensor data may correspond to a particular room within an overall site (e.g., may reflect a room where the robot is located and may not reflect a room where the robot is not located) and the site model may correspond to the overall site (e.g., each room or area within the site).

In some cases, the site model and the sensor data may have different image data parameters (e.g., different resolutions, different contrasts, different brightness, etc.), and/or different viewpoints (e.g., the site model may provide a vertically oriented view and the sensor data may provide a horizontally oriented view).

The computing system may transform the sensor data and the site model to generate transformed data. The computing system may generate the transformed data in a particular data format. To transform the transformed data, the computing system may transform the sensor data (e.g., from a first data format to a third data format), transform the site model (e.g., from a second data format to the third data format), and combine (e.g., adjoin, append, join, link, collate, concatenate, etc.) the transformed sensor data and the transformed site model. For example, the computing system may collate the transformed sensor data and the transformed site model by assembling the transformed sensor data and the transformed site model in a particular arrangement or order (e.g., based on a programming language). In another example, the computing system may collate the transformed sensor data and the transformed site model by integrating the transformed sensor data and the transformed site model into the transformed data.

The computing system may identify an action for performance based on the transformed data and/or the prompt data. In some cases, to identify the action, the computing system may provide (e.g., directly or indirectly) the transformed data and/or the prompt data to a machine learning model (e.g., implemented by the computing system or a different computing system) trained to output an action (e.g., an identifier of the action) based on input data. For example, the computing system may generate a prompt (e.g., a system prompt, a state prompt, etc.) based on the transformed data and/or the prompt data and may provide the prompt to the machine learning model. In some cases, the prompt data may be and/or may include the prompt.

The computing system may identify the action based on the output of the machine learning model. In some cases, the computing system may provide the transformed data and/or the prompt data (or the prompt) to a second computing system (e.g., implementing the machine learning model) and the computing system may obtain an output of the second computing system. The computing system may identify an action based the output of the computing system.

In some cases, the computing system may identify different actions (or different manners of performing the same action) based on a persona of the robot and/or a persona of an entity within the site (e.g., a persona assigned by the computing system). For example, the computing system may identify a first manner for the robot to perform the action based on a first persona (of the robot and/or an entity) and a second manner for the robot to perform the action based on a second persona (of the robot and/or an entity). In another example, the robot may identify a first action for performance based on the transformed data and a first persona and may identify a second action for performance based on the transformed data and a second persona.

The computing system may instruct performance of the action by the robot. For example, the action may include output of audio data, output of image data, movement of the robot (e.g., movement of an appendage of the robot), etc. In some cases, the computing system may instruct performance of one or more synchronized actions by the robot. For example, the computing system may instruct the robot to synchronize movement of an appendage of the robot (e.g., a hand member located at an end of an arm of the robot) with output of audio data via a speaker of the robot such that it appears that the appendage is speaking the audio data.

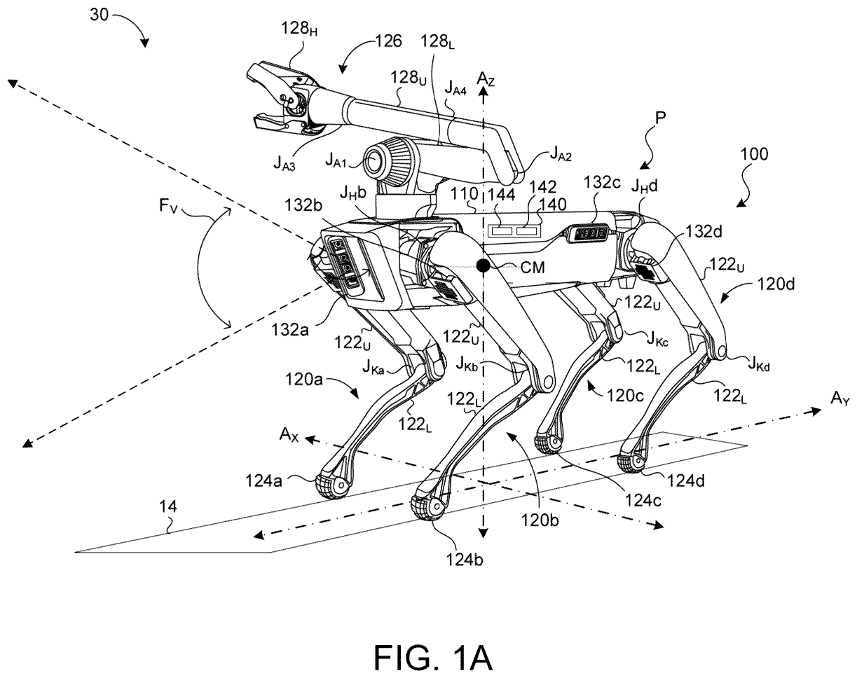

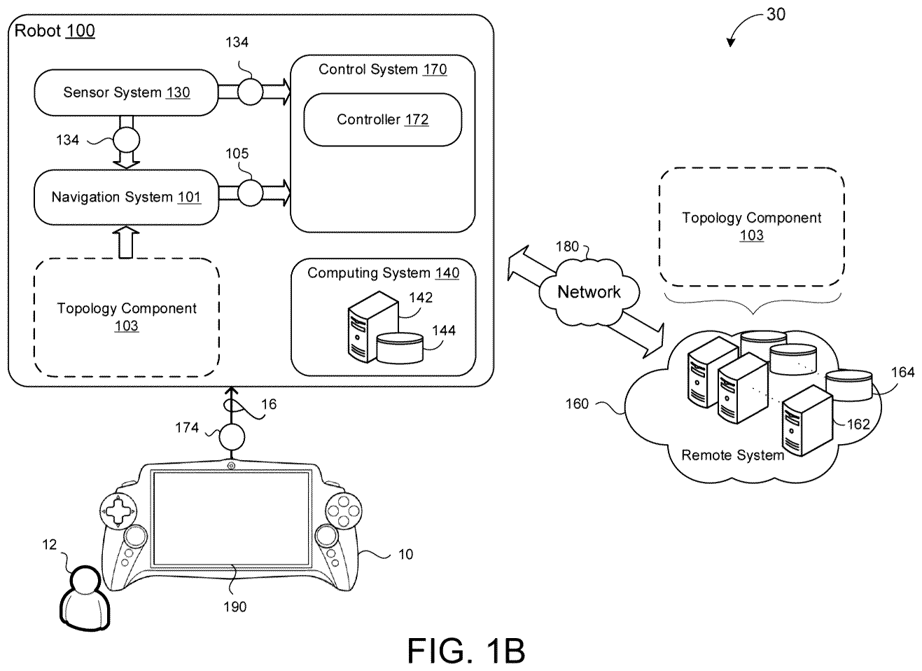

Referring to FIGS. 1A and 1B, in some implementations, a robot 100 includes a body 110 with one or more locomotion-based structures such as a front right leg 120a (e.g., a first leg, a stance leg), a front left leg 120b (e.g., a second leg), a hind right leg 120c (e.g., a third leg), and a hind left leg 120d (e.g., a fourth leg) coupled to the body 110 that enable the robot 100 to move within a site 30 that surrounds the robot 100. In some examples, all or a portion of the legs may be an articulable structure such that one or more joints J permit members of the respective leg to move. For instance, in the illustrated embodiment, all or a portion of the front right leg 120a, the front left leg 120b, the hind right leg 120c, and the hind left leg 120d include a hip joint J_{H} coupling an upper member 122c of the respective leg to the body 110 and a knee joint J_{K} coupling the upper member 122c of the respective leg to a lower member 1221, of the respective leg. Although FIG. 1A depicts a quadruped robot with a front right leg 120a, a front left leg 120b, a hind right leg 120c, and a hind left leg 120d, the robot 100 may include any number of legs or locomotive based structures (e.g., a biped or humanoid robot with two legs, or other arrangements of one or more legs) that provide a means to traverse the terrain within the site 30.

In order to traverse the terrain, all or a portion of the front right leg 120a, the front left leg 120b, the hind right leg 120c, and the hind left leg 120d may have a respective distal end (e.g., the front right leg 120a may have a distal end 124a, the front left leg 120b may have a distal end 124b, the hind right leg 120c may have a distal end 124c, and the hind left leg 120d may have a distal end 124d) that contacts a surface of the terrain (e.g., a traction surface). In other words, the distal end may be the end of the leg used by the robot 100 to pivot, plant, or generally provide traction during movement of the robot 100. For example, the distal end may corresponds to a foot of the robot 100. In some examples, though not shown, the distal end of the leg includes an ankle joint such that the distal end is articulable with respect to the lower member 122_{L} of the leg.

In the examples shown, the robot 100 includes an arm 126 that functions as a robotic manipulator. The arm 126 may move about multiple degrees of freedom in order to engage elements of the site 30 (e.g., objects within the site 30). In some examples, the arm 126 includes one or more members, where the members are coupled by joints J such that the arm 126 may pivot or rotate about the joint(s) J. For instance, with more than one member, the arm 126 may extend or retract. To illustrate an example, FIG. 1A depicts the arm 126 with three members corresponding to a lower member 128_{L}, an upper member 128_{U}, and a hand member 128_{H} (also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIG. 1A, the hand member 128_{H} is a mechanical gripper that includes a moveable jaw and a fixed jaw may perform different types of grasping of elements within the site 30. In the example shown, the hand member 128_{H} includes a fixed first jaw and a moveable second jaw that grasps objects by clamping the object between the jaws. The moveable jaw may move relative to the fixed jaw to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the legs relative to the body 110 alters the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where distal end 124a, distal end 124b, distal end 124c, and distal end 124d of the robot 100 may generate traction to help the robot 100 move within the site 30. Another anatomical plane of the robot 100 is the frontal plane that extends across the body 110 of the robot 100 (e.g., from a right side of the robot 100 with a front right leg 120a to a left side of the robot 100 with a front left leg 120b). The frontal plane spans the X-Z plane by extending in directions of the x-direction axis A_{X} and the z-direction axis A_{Z}.

In order to maneuver within the site 30 or to perform tasks using the arm 126, the robot 100 includes a sensor system 130 with one or more sensors. For example, FIG. 1A illustrates a first sensor 132a mounted at a head of the robot 100 (near a front portion of the robot 100 adjacent the front right leg 120a and the front left leg 120b), a second sensor 132b mounted near the hip J_{H}b of the front left leg 120b of the robot 100, a third sensor 132c mounted on a side of the body 110 of the robot 100, and a fourth sensor 132d mounted near the hip J_{H}d of the hind left leg 120d of the robot 100. In some cases, the sensor system may include a fifth sensor mounted at or near the hand member 128_{H} of the arm 126 of the robot 100. The one or more sensors may include vision/image sensors, inertial sensors (e.g., an inertial measurement unit (IMU)), force sensors, and/or kinematic sensors. For example, the one or more sensors may include one or more of a camera (e.g., a stereo camera), a time-of-flight (TOF) sensor, a scanning light-detection and ranging (lidar) sensor, or a scanning laser-detection and ranging (ladar) sensor. In some examples, all or a portion of the one or more sensors has a corresponding field(s) of view F_{V} defining a sensing range or region corresponding to the respective sensor. For instance, FIG. 1A depicts a field of a view F_{V} for the first sensor 132a of the robot 100. All or a portion of the one or more sensors may be pivotable and/or rotatable such that the respective sensor, for example, may change the field of view F_{V} about one or more axes (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With multiple sensors placed about the robot 100, the sensor system may have a 360 degree view or a nearly 360 degree view of the surroundings of the robot 100 about vertical and/or horizontal axes.

When surveying a field of view F_{V} with a sensor, the sensor system generates sensor data 134 (e.g., image data, joint-based sensor data, etc.) corresponding to the field of view F_{V} (see, e.g., FIG. 1B). The sensor system may generate the field of view F_{V} with a sensor mounted on or near the body 110 of the robot 100 (e.g., the first sensor 132a, the third sensor 132c). The sensor system may additionally and/or alternatively generate the field of view F_{V} with a sensor mounted at or near the hand member 128_{H} of the arm 126. The one or more sensors capture the sensor data 134 that defines the three-dimensional point cloud for the area within the site 30 of the robot 100. In some examples, the sensor data 134 is image data that corresponds to a three-dimensional volumetric point cloud generated by a three-dimensional volumetric image sensor. Additionally or alternatively, when the robot 100 is maneuvering within the site 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data 134, various systems of the robot 100 may use the sensor data 134 to define a current state of the robot 100 (e.g., of the kinematics of the robot 100) and/or a current state of the site 30 of the robot 100. In other words, the sensor system may communicate the sensor data 134 from one or more sensors to any other system of the robot 100 in order to assist the functionality of that system.

In some implementations, the sensor system includes one or more sensors coupled to a joint J. Moreover, the one or more sensors may couple to a motor M that operates a joint J of the robot 100. The one or more sensors may generate joint dynamics in the form of sensor data 134 (e.g., joint-based sensor data). Joint dynamics collected as joint-based sensor data may include joint angles (e.g., an upper member 122_{U} relative to a lower member 122_{L} or hand member 126_{H} relative to another member of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor may measure joint position (or a position of member(s) coupled at a joint J) and systems of the robot 100 perform further processing to derive velocity and/or acceleration from the positional data. In other examples, a sensor may measure velocity and/or acceleration directly.

With reference to FIG. 1B, as the sensor system 130 gathers sensor data 134, a computing system 140 stores, processes, and/or to communicates the sensor data 134 to various systems of the robot 100 (e.g., the control system 170, a navigation system 101, a topology component 103, and/or remote controller 10). In order to perform computing tasks related to the sensor data 134, the computing system 140 of the robot 100 includes data processing hardware 142 and memory hardware 144. The data processing hardware 142 may execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg of the robot 100) while a centralized computing system may allow for a central processing hub that communicates to systems located at various positions on the robot 100 (e.g., communicate to the motor that moves the joint of the leg of the robot 100).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 may utilize the remote data processing hardware 162 and the remote memory hardware 164 as extensions of the data processing hardware 142 and the memory hardware 144 such that resources of the computing system 140 reside on resources of the remote system 160. In some examples, the topology component 103 is executed on the data processing hardware 142 local to the robot, while in other examples, the topology component 103 is executed on the remote data processing hardware 162 that is remote from the robot 100.

In some implementations, as shown in FIGS. 1A and 1B, the robot 100 includes a control system 170. The control system 170 may communicate with systems of the robot 100, such as the sensor system 130 (e.g., at least one sensor system), the navigation system 101, and/or the topology component 103. For example, the navigation system 101 may provide a step plan 105 to the control system 170. The control system 170 may perform operations and other functions using hardware such as the computing system 140. The control system 170 includes a controller 172 (e.g., at least one controller) that may control the robot 100. For example, the controller 172 (e.g., a programmable controller) may control movement of the robot 100 to traverse the site 30 based on input or feedback from the systems of the robot 100 (e.g., the sensor system 130 and/or the control system 170). In additional examples, the controller 172 may control movement between poses and/or behaviors of the robot 100. The controller 172 may control movement of the arm 126 of the robot 100 in order for the arm 126 to perform various tasks using the hand member 128_{H}. For instance, the controller 172 may control the hand member 128_{H} (e.g., a gripper) to manipulate an object or element in the site 30. For example, the controller 172 may actuate the movable jaw in a direction towards the fixed jaw to close the gripper. In other examples, the controller 172 may actuate the movable jaw in a direction away from the fixed jaw to close the gripper.

The controller 172 may control the robot 100 by controlling movement about one or more joints J of the robot 100. In some configurations, the controller 172 may be software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the controller 172 may control an amount of force that is applied to a joint J (e.g., torque at a joint J). The number of joints J that the controller 172 controls may be scalable and/or customizable for a particular control purpose. The controller 172 may control a single joint J (e.g., control a torque at a single joint J), multiple joints J, or actuation of one or more members (e.g., actuation of the hand member 128_{H}) of the robot 100. By controlling one or more joints J, actuators or motors M, the controller 172 may coordinate movement for all different parts of the robot 100 (e.g., the body 110, one or more legs of the robot 100, the arm 126). For example, to perform a behavior with some movements, the controller 172 may control movement of multiple parts of the robot 100 such as, for example, the front right leg 120a and the front left leg 120b, the front right leg 120a, the front left leg 120b, the hind right leg 120c, and the hind left leg 120d, or the front right leg 120a and the front left leg 120b combined with the arm 126. In some examples, the controller 172 may be an object-based controller that is set up to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 may display the image that corresponds to three-dimensional field of view F_{V} of the one or more sensors. The image displayed on the user interface 190 of the remote controller 10 is a two-dimensional image that corresponds to the three-dimensional point cloud of sensor data 134 (e.g., field of view F_{V}) for the area within the site 30 of the robot 100. That is, the image displayed on the user interface 190 may be a two-dimensional image representation that corresponds to the three-dimensional field of view F_{V} of the one or more sensors.

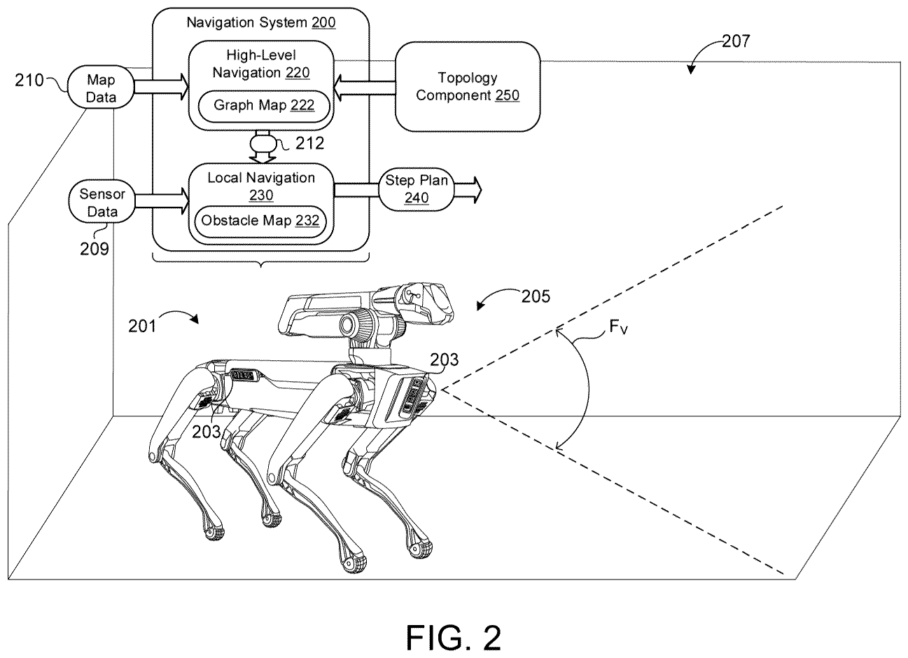

Referring now to FIG. 2, the robot 201 (e.g., the data processing hardware 142 as discussed above with reference to FIGS. 1A and 1B) executes a navigation system 200 for enabling the robot 201 to navigate the site 207. The sensor system 205 includes one or more sensors 203 (e.g., image sensors, lidar sensors, ladar sensors, etc.) that can each capture sensor data 209 of the site 207 surrounding the robot 201 within the field of view F_{V}. For example, the one or more sensors 203 may be one or more cameras. The sensor system 205 may move the field of view F_{V} by adjusting an angle of view or by panning and/or tilting (either independently or via the robot 201) one or more sensors 203 to move the field of view F_{V} in any direction. In some implementations, the sensor system 205 includes multiple sensors (e.g., multiple cameras) such that the sensor system 205 captures a generally 360-degree field of view around the robot 201. The navigation system 200 may include and/or may be similar to the navigation system 101 discussed above with reference to FIG. 1B, the topology component 250 may include and/or may be similar to the topology component 103 discussed above with reference to FIG. 1B, the step plan 240 may include and/or may be similar to the step plan 105 discussed above with reference to FIG. 1B, the robot 201 may include and/or may be similar to the robot 100 discussed above with reference to FIGS. 1A and 1B, the one or more sensors 203 may include and/or may be similar to the one or more sensors discussed above with reference to FIG. 1A, the sensor system 205 may include and/or may be similar to the sensor system 130 discussed above with reference to FIGS. 1A and 1B, the site 207 may include and/or may be similar to the site 30 discussed above with reference to FIGS. 1A and 1B, and/or the sensor data 209 may include and/or may be similar to the sensor data 134 discussed above with reference to FIG. 1B.

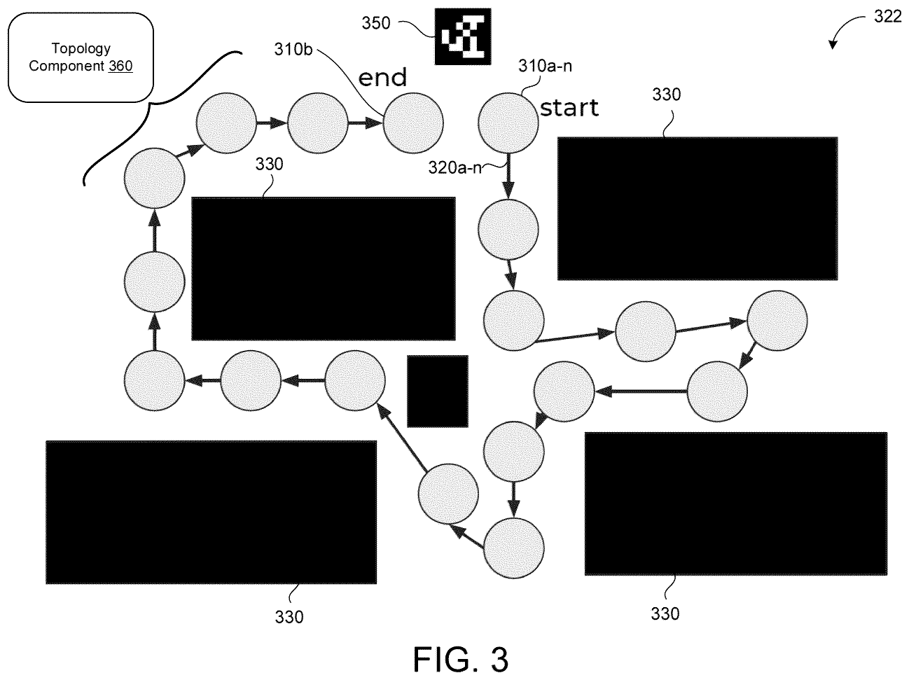

In the example of FIG. 2, the navigation system 200 includes a high-level navigation module 220 that receives map data 210 (e.g., high-level navigation data representative of locations of static obstacles in an area the robot 201 is to navigate). In some cases, the map data 210 includes a graph map 222. In other cases, the high-level navigation module 220 generates the graph map 222. The graph map 222 may include a topological map of a given area the robot 201 is to traverse. The high-level navigation module 220 can obtain (e.g., from the remote system 160 or the remote controller 10 or the topology component 250) and/or generate a series of route waypoints (as shown in FIG. 3) on the graph map 222 for a navigation route 212 that plots a path around large and/or static obstacles from a start location (e.g., the current location of the robot 201) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints and the route edges may be representative of the navigation route 212 for the robot 201 to follow from a start location to a destination location.

As discussed in more detail below, in some examples, the high-level navigation module 220 receives the map data 210, the graph map 222, and/or an optimized graph map from a topology component 250. The topology component 250, in some examples, is part of the navigation system 200 and executed locally at or remote from the robot 201.

In some implementations, the high-level navigation module 220 produces the navigation route 212 over a greater than 10-meter scale (e.g., the navigation route 212 may include distances greater than 10 meters from the robot 201). The scale for the high-level navigation module 220 can be set based on the robot 201 design and/or the desired application, and is typically larger than the range of the one or more sensors 203. The navigation system 200 also includes a local navigation module 230 that can receive the navigation route 212 and the sensor data 209 (e.g., image data) from the sensor system 205. The local navigation module 230, using the sensor data 209, can generate an obstacle map 232. The obstacle map 232 may be a robot-centered map that maps obstacles (static and/or dynamic obstacles) in the vicinity (e.g., within a threshold distance) of the robot 201 based on the sensor data 209. For example, while the graph map 222 may include information relating to the locations of walls of a hallway, the obstacle map 232 (populated by the sensor data 209 as the robot 201 traverses the site 207) may include information regarding a stack of boxes placed in the hallway that were not present during the original recording. The size of the obstacle map 232 may be dependent upon both the operational range of the one or more sensors 203 and the available computational resources.

The local navigation module 230 can generate a step plan 240 (e.g., using an A* search algorithm) that plots all or a portion of the individual steps (or other movements) of the robot 201 to navigate from the current location of the robot 201 to the next route waypoint along the navigation route 212. Using the step plan 240, the robot 201 can maneuver through the site 207. The local navigation module 230 may obtain a path for the robot 201 to the next route waypoint using an obstacle grid map based on the sensor data 209 (e.g., the captured sensor data). In some examples, the local navigation module 230 operates on a range correlated with the operational range of the one or more sensors 203 (e.g., four meters) that is generally less than the scale of high-level navigation module 220.

Referring now to FIG. 3, in some examples, the topology component 360 obtains the graph map 322 (e.g., a topological map) of a site (e.g., the site 30 as discussed above with reference to FIGS. 1A and 1B). For example, the topology component 360 receives the graph map 322 from a navigation system (e.g., the high-level navigation module 220 of the navigation system 200 as discussed above with reference to FIG. 2) or generates the graph map 322 from map data (e.g., map data 210 as discussed above with reference to FIG. 2) and/or sensor data (e.g., sensor data 134 as discussed above with reference to FIGS. 1A and 1B). The graph map 322 may be similar to and/or may include the graph map 222 discussed above with reference to FIG. 2. The topology component 360 may be similar to and/or may include the topology component 250 discussed above with reference to FIG. 2. The graph map 322 includes a series of route waypoints 310a-n and a series of route edges 320a-n. Each route edge in the series of route edges 320a-n topologically connects a corresponding pair of adjacent route waypoints in the series of route waypoints 310a-n. Each route edge represents a traversable route for a robot (e.g., the robot 100 as discussed above with reference to FIGS. 1A and 1B) through a site of the robot. The map may also include information representing one or more obstacles 330 that mark boundaries where the robot may be unable to traverse (e.g., walls and static objects). In some cases, the graph map 322 may not include information regarding the spatial relationship between route waypoints. The robot may record the series of route waypoints 310a-n and the series of route edges 320a-n using odometry data captured by the robot as the robot navigates the site. The robot may record sensor data at all or a portion of the route waypoints such that all or a portion of the route waypoints are associated with a respective set of sensor data captured by the robot (e.g., a point cloud). In some implementations, the graph map 322 includes information related to one or more fiducial markers 350. The one or more fiducial markers 350 may correspond to an object that is placed within the field of sensing of the robot that the robot may use as a fixed point of reference. The one or more fiducial markers 350 may be any object that the robot is capable of readily recognizing, such as a fixed or stationary object of the site or an object with a recognizable pattern. For example, a fiducial marker of the one or more fiducial markers 350 may include a bar code, QR-code, or other pattern, symbol, and/or shape for the robot to recognize.

In some cases, the robot may navigate along valid route edges and may not navigate along between route waypoints that are not linked via a valid route edge. Therefore, some route waypoints may be located (e.g., metrically, geographically, physically, etc.) within a threshold distance (e.g., five meters, three meters, etc.) without the graph map 322 reflecting a route edge between the route waypoints. In the example of FIG. 3, the route waypoint 310a and the route waypoint 310b are within a threshold distance (e.g., a threshold distance in physical space or reality), Euclidean space, Cartesian space, and/or metric space, but the robot, when navigating from the route waypoint 310a to the route waypoint 310b, may navigate the entire series of route edges 320a-n due to the lack of a route edge directly connecting the route waypoints 310a, 310b. Therefore, the robot may determine, based on the graph map 322, that there is no direct traversable path between the route waypoints 310a, 310b. The graph map 322 may represent the route waypoints 310 in global (e.g., absolute positions) and/or local positions where positions of the route waypoints are represented in relation to one or more other route waypoints. The route waypoints may be assigned Cartesian or metric coordinates, such as 3D coordinates (x, y, z translation) or 6D coordinates (x, y, z translation and rotation).

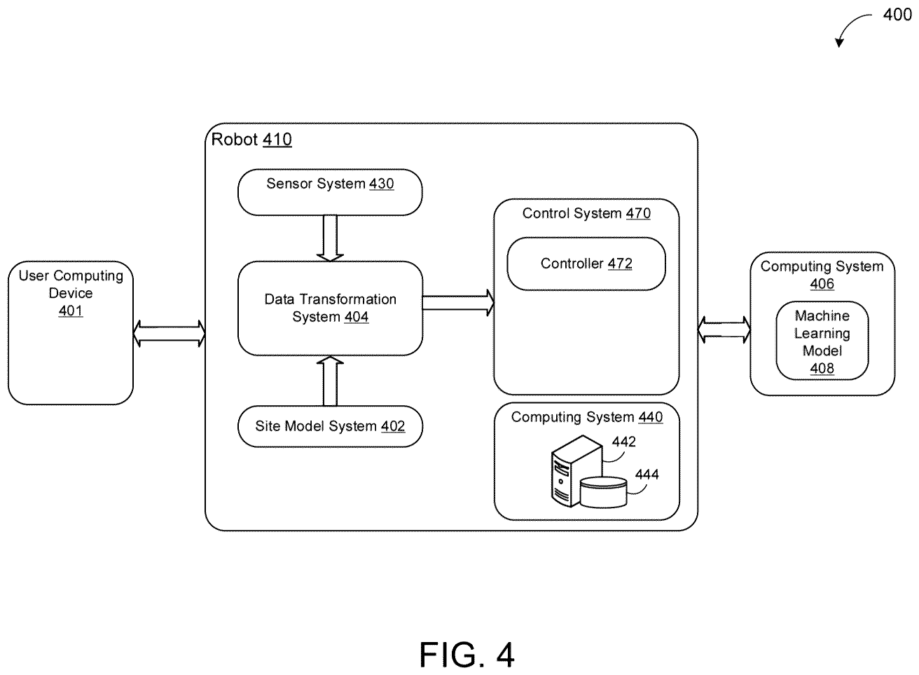

Referring now to FIG. 4, as discussed above with reference to FIG. 1B, the robot 410 can include a sensor system 430, a data transformation system 404, a computing system 440, a control system 470, and a site model system 402. The robot 410 may include and/or may be similar to the robot 100 discussed above with reference to FIGS. 1A and 1B. The sensor system 430 can gather sensor data and the site model system 402 can gather a site model. The sensor system 430 may include and/or may be similar to the sensor system 130 discussed above with reference to FIGS. 1A and 1B. The data transformation system 404 can store, process (e.g., transform), and/or communicate the sensor data and/or the site model to various systems of the robot 410 (e.g., the control system 470). The computing system 440 includes data processing hardware 442 and memory hardware 444. The computing system 440 may include and/or may be similar to the computing system 140 discussed above with reference to FIGS. 1A and 1B, the data processing hardware 442 may include and/or may be similar to the data processing hardware 142 discussed above with reference to FIGS. 1A and 1B, and the memory hardware 444 may include and/or may be similar to the memory hardware 144 discussed above with reference to FIGS. 1A and 1B. The control system 470 includes a controller 472. The control system 470 may include and/or may be similar to the control system 170 discussed above with reference to FIGS. 1A and 1B and the controller 472 may include and/or may be similar to the controller 172 discussed herein. In some cases, the controller 472 may include a plurality of controllers.

The robot 410 can be in communication with a user computing device 401 and/or a computing system 406 (e.g., via a network).

In the example of FIG. 4, the sensor system 430 and the site model system 402 are in communication with the data transformation system 404. For example, the data transformation system 404 may include a sensor data transformation system and/or a site model transformation system. In some cases, the sensor system 430 and/or the site model system 402 may include all or a portion of the data transformation system 404.

The sensor system 430 may include a plurality of sensors (e.g., five sensors). For example, the sensor system 430 may include a plurality of sensors distributed across the body, one or more legs, arm, etc. of the robot 410. The sensor system 430 may receive sensor data from each of the plurality of sensors. The sensors may include at least two different types of sensors. For example, the sensor may include lidar sensors, image sensors, ladar sensors, audio sensors, etc. and the sensor data may include lidar sensor data, image (e.g., camera) sensor data, ladar sensor data, audio data, etc.

In some cases, the sensor data may include three-dimensional point cloud data. The sensor system 430 (or a separate system) may use the three-dimensional point cloud data to detect and track features within a three-dimensional coordinate system. For example, the sensor system 430 may use the three-dimensional point cloud data to detect and track movers within the site.

The sensor system 430 may obtain a first portion of sensor data (e.g., audio data). The sensor system 430 may provide the first portion of sensor data to the computing system 440. The computing system 440 may determine whether the first portion of sensor data corresponds to particular sensor data (e.g., using speech recognition). For example, the computing system 440 may determine whether the first portion of sensor data includes audio data corresponding to a particular wake word, includes position data corresponding to a button press, etc. Based on determining the first portion of sensor data corresponds to particular sensor data, the computing system 440 may initiate capture by the sensor system 430 of a second portion of sensor data (e.g., additional audio data).

In some cases, the computing system 440 may obtain second sensor data via the sensor system 430 and may identify an entity at the site based on the second sensor data. The computing system 440 may instruct movement of the robot 410 in a direction towards the entity and output of audio data by a speaker of the robot 410. For example, the computing system 440 may instruct movement of an arm of the robot 410 such that the arm is oriented in a direction towards the entity. Further, based on orienting the arm in a direction towards the entity, the computing system 440 may synchronize further movement of the robot 410 (e.g., a hand member) and output of the audio data such that the robot 410 (e.g., the hand member) appears to be speaking. In some cases, the audio data may include audio data requesting additional sensor data (e.g., requesting additional audio instructions), alerting an entity that the robot 410 is capturing additional sensor data, etc.

The site model system 402 may obtain the site model (e.g., from a user computing device). For example, a user computing device may provide a site model of a site to the site model system 402. The site model system 402 may determine location data (e.g., coordinates, a location identifier, etc.) associated with the site model. For example, the site model system 402 may obtain a site model of a site and location data indicating a location of the site. In some cases, the site model system 402 may store the site model and the location data in a location data store.

The site model system 402 may obtain a request to provide a site model of a particular site. For example, the request may include location data of the robot 410. In some cases, the site model system 402 may obtain the request based on prompt data (e.g., obtained from a user), audio data (e.g., audio instructions requesting performance of an action), etc. associated with the robot 410 at a particular location. For example, the computing system 440 may provide the request in response to obtaining prompt data.

In response to the request, the site model system 402 may identify a site model (e.g., in the site model data store) associated with the location data and may provide the site model. In some cases, in response to the request, the site model system 402 may determine the location data is not associated with a site model and may request a site model (e.g., from a user computing device).

In some cases, the site model system 402 may receive the site model from one or more sensors of the robot 410 (e.g., distributed across the robot 410). For example, a sensor of the robot 410 may capture sensor data indicative of the site model.

The site model and the sensor data may have different data formats (e.g., JPEG, Portable Network Graphics (“PNG”) data format, different processing statuses (e.g., unprocessed (e.g., raw) data, processed data), different data types (e.g., lidar data, ladar data, image data, etc.), etc., may be captured via different data sources (e.g., sensors at different locations, sensors located on the robot 410 and sensors located remotely from the robot 410, etc.), may correspond to different locations (e.g., areas of the site), different image data parameters (e.g., different resolutions, different contrasts, different brightness, etc.), and/or different viewpoints (e.g., the site model may provide a vertically oriented view and the sensor data may provide a horizontally oriented view).

In some cases, the sensor data and/or the site model may be annotated. For example, the sensor data may be annotated sensor data with one or more first semantic labels and/or the site model may be an annotated site model with one or more second semantic labels.

In some cases, the sensor system 430 and/or the site model system 402 (or a separate component of the robot 410 such as the computing system 440, a sense system, etc.) may annotate the sensor data and/or the site model respectively. For example, the sensor system 430 and/or the site model system 402 may implement a machine learning model that outputs annotated data based on received input. In another example, the sensor system 430 and/or the site model system 402 may output semantic tokens in a human language (e.g., English text) based on sensor data and/or a site model.

In some cases, the sensor system 430 and/or the site model system 402 may provide the sensor data and/or the site model to a separate computing system (e.g., implementing a machine learning model) for annotation of the sensor data and/or the site model.

In some cases, the sensor system 430 and/or the site model system 402 may provide the sensor data and/or the site model respectively to a user computing device 401 for annotation. For example, the sensor system 430 and/or the site model system 402 may cause display of a user interface on the user computing device 401. The user interface may include the sensor data and/or the site model and may enable a user to annotate the sensor data and/or the site model. The sensor system 430 and/or the site model system 402 may obtain annotated sensor data and/or an annotated site mode from the user computing device 401.

The sensor system 430 and the site model system 402, respectively, may provide the sensor data to the data transformation system 404 for transformation. For example, the sensor system 430 may provide the sensor data and the site model system 402 may provide the site model to the data transformation system as one or more batches or as a data stream.

A computing system of the robot 410 (e.g., the computing system 440) can obtain prompt data. For example, the computing system 440 may obtain prompt data from the user computing device 401. The prompt data may indicate a persona of the robot 410, an action identifier for the robot 410, communication parameters, and/or an entity identifier.

In some cases, the computing system 440 may generate all or a portion of the prompt data. For example, the computing system 440 may dynamically build the prompt data based on the sensor data and/or the site model.

To identify an entity identifier of the prompt data, the computing system 440 may identify an entity located at the site based on the sensor data. The computing system 440 may process the sensor data (e.g., perform image recognition) and may identify an entity identifier (e.g., John Doe) associated with the entity (e.g., assigned to, linked to, etc. the entity). For example, the computing system 440 may determine an entity data store stores data linking the entity identifier to the entity. In some cases, the computing system 440 may determine that an entity identifier is not associated with the entity and may generate (e.g., using a machine learning model) and store an entity identifier associated with the entity.

To identify a persona of the robot 410, the computing system 440 may select a persona (from a plurality of personas) of the robot 410 based on the sensor data and/or the site model. The computing system 440 may select a particular persona based on the sensor data and/or the site model indicating one or more features. For example, the computing system 440 may select a first persona (e.g., a snarky persona) based on the sensor data indicating that no children are located at the site and may select a second persona (e.g., an energetic, positive persona) based on the sensor data indicating that multiple children are located at the site. In another example, the computing system 440 may select a first persona (e.g., a tour guide persona) based on the site model indicating that the site is a museum and a second persona (e.g., a receptionist persona) based on the site model indicating that the site is a business headquarters. In some cases, a user may provide an input selecting a persona from a plurality of personas.

In some cases, based on the entity identifier, the computing system 440 may identify one or more communication parameters for communication with the entity. In some cases, the entity data store may store data linking the entity identifier to the entity and one or more communication parameters. For example, a user computing device may provide the data linking the entity identifier to the entity and the one or more communication parameters to the computing system 440. The one or more communication parameters may indicate a manner of communicating with the entity. For example, the one or more communication parameters may include a particular persona, a particular language, a particular dialect, a particular background, a particular audio speed, a particular audio tempo, a particular preferred terminology, etc.

The data transformation system 404 may obtain the sensor data, the site model, and/or the prompt data and may transform the sensor data, the site model, and/or the prompt data. In some cases, the data transformation system 404 may transform the sensor data and the site model to a particular data format (e.g., a text-based data format). For example, the data transformation system 404 may transform the sensor data from a first data format to the third data format and may transform the site model from a second data format to the third data format. In some cases, the data transformation system 404 may translate the sensor data and/or the site model into one or more annotations. For example, the sensor system 430, the site model system 402, the computing system 440, the sense system, etc. may translate image data and/or audio data into text data (representing one or more semantic tokens).

In some cases, the data transformation system 404 may combine (e.g., adjoin, append, join, link, collate, concatenate, etc.) the transformed sensor data and the transformed site model to generate transformed data. For example, the data transformation system 404 may collate the transformed sensor data and the transformed site model by assembling the transformed sensor data and the transformed site model in a particular arrangement or order (e.g., based on a programming language). Further, the data transformation system 404 may combine the transformed sensor data, the transformed site model, and the prompt (transformed or untransformed) to generate transformed data.

In some cases, to transform the sensor data and/or the site model, the data transformation system 404 may identify one or more semantic labels associated with the sensor data and/or the site model. For example, the data transformation system 404 may parse the sensor data and/or the site model to identify the one or more semantic labels and may generate text data (e.g., the transformed data) that includes the one or more semantic labels (e.g., combined).

The transformed data (e.g., the one or more semantic labels) and the prompt data may include data according to a particular language (e.g., a computer language, a programming language, etc.). For example, the language may be Python, Java, C++, Ruby, etc. The computing system may obtain the prompt data and/or the transformed data in the particular language and/or may adjust the prompt data and/or the transformed data to confirm to the particular language.

The control system 470 can route the transformed sensor data, the transformed site model, and/or the prompt data to the computing system 406. For example, the control system 470 may route the transformed data to the computing system 406. In some cases, the computing system 440 may generate a prompt based on the transformed sensor data, the transformed site model, and the prompt data (e.g., using prompt engineering) and the control system 470 may route the prompt to the computing system 406. The computing system 406 may implement a machine learning model 408. For example, the machine learning model 408 may be a large language model such as ChatGPT.

In some cases, the robot 410 (or a component of the robot 410) may implement the machine learning model 408 and the control system 470 may not route the transformed sensor data, the transformed site model, and/or the prompt data (or the prompt) to the computing system 406. For example, the robot 410 may include a semantic processor (e.g., implementing a machine learning model such as a large language model). The semantic processor may be trained to output annotations (e.g., semantic tokens) based on sensor data and/or a site model and may be prompted by prompt data (e.g., a script). For example, the semantic processor may obtain one or more semantic tokens (e.g., in English text) associated with sensor data and/or a site model and output one or more additional semantic tokens (e.g., in English text).

In some cases, the control system 470 may route the sensor data, the site model, and/or the prompt data to the computing system 406 and may not route transformed sensor data and/or a transformed site model.

The machine learning model 408 may be trained on training data to output an action based on obtained input. For example, the machine learning model 408 may be trained to output an action (or an identifier of an action) based on input sensor data, an input site model, and/or input prompt data. In some cases, the machine learning model 408 may be trained to output an action based on data having a particular data format (e.g., a text data format). In some cases, the machine learning mode may be trained to output an action based on data having multiple data formats (e.g., a text data format, an image sensor based data format, a lidar sensor based data format, etc.).

The machine learning model 408 may output an action (or an identifier of the action) based on the transformed sensor data, the transformed site model, and/or the prompt data. The computing system 406 may provide the action to the robot 410 (e.g., the computing system 440 of the robot 410).

In some cases, the machine learning model 408 may output a text based action. For example, the machine learning model 408 may output a string of text: “Welcome to the Museum.” The computing system 440 may include a text-to-audio component (e.g., a text-to-speech system) that converts text data (e.g., a string of text) into audio for output by the computing system 440.

The computing system 440 may generate and/or implement one or more actions based on the action identified by the computing system 406. The one or more actions may include one or more actions to be performed by the robot 410. For example, the one or more actions may include an adjustment to the navigational behavior of the robot 410, a physical action (e.g., an interaction) to be implemented by the robot 410, an alert to be displayed by the robot 410, engaging specific systems for interacting with the entity (e.g., for recognizing human gestures or negotiating with persons), and/or a user interface to be displayed by the robot 410. The particular action may also involve larger systems than the robot 410 itself, such as calling for assistance from a person in robot management or communicating with other robots within a multi-robot system in response to recognition of particular types of movers from the fused data.

For example, the one or more actions may include a movement of the robot 410 and/or output of data (e.g., audio data) by the robot 410. In some cases, the computing system 440 may synchronize the data and the movement of the robot 410. For example, the computing system 440 may synchronize audio data and movement of a hand member of the robot 410 such that the hand member appears to be speaking the audio data.

The computing system 440 may route the one or more actions (or an identifier of the one or more actions) to a particular system of the robot 410. For example, the computing system 440 may include a navigation system (e.g., the navigation system 200 referenced in FIG. 2). The computing system 440 may determine that the action includes an adjustment to the navigational behavior of the robot 410 and may route the action to the navigation system to cause an adjustment to the navigational behavior of the robot 410.

In some cases, the computing system 440 may route the one or more actions (or an identifier of the one or more actions) to the control system 470. The control system 470 may implement the one or more actions using the controller 472 to control the robot 410. For example, the controller 472 may control movement of the robot 410 to traverse a site based on input or feedback from the systems of the robot 410 (e.g., the sensor system 430 and/or the control system 470). In another example, the controller 472 may control movement of an arm and/or leg of the robot 410 to cause the arm and/or leg to interact with a mover (e.g., wave to the mover).

In some cases, the computing system 440 (or another system of the robot 410) may route the one or more actions (or an identifier of the one or more actions) to a second computing system separate from the robot 410 (e.g., located separately and distinctly from the robot 410). For example, the computing system 440 may route the one or more actions to a user computing device of a user (e.g., a remote controller of an operator, a user computing device of an entity within the site, etc.), a computing system of another robot, a centralized computing system for coordinating multiple robots within a facility, a computing system of a non-robotic machine, etc. Based on routing the one or more actions to the second computing system, the computing system 440 may cause the second computing system to provide an alert, display a user interface, etc.

In some cases, the one or more actions may be persona-based actions such that actions based on a first persona are different as compared to actions based on a second persona. The one or more actions may be one or more first actions (e.g., outputting first audio data) based on transformed sensor data, a transformed site model, and a first persona and the one or more actions may be one or more second actions (e.g., outputting second audio data) based on the transformed sensor data, the transformed site model, and a second persona.

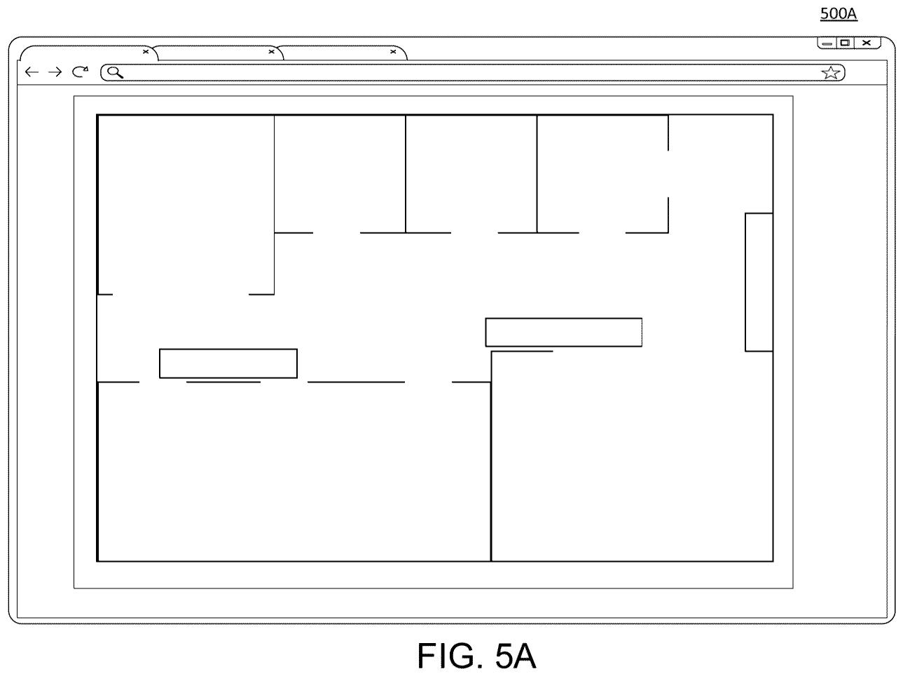

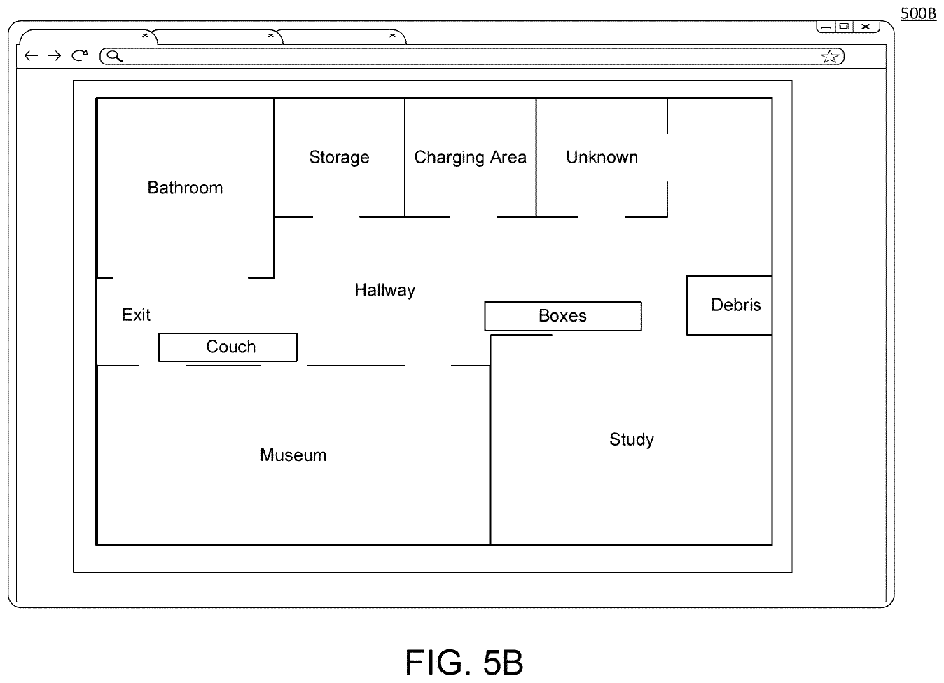

To illustrate an example site model obtained by a computing system, FIG. 5A depicts a schematic view 500A of a site model. In some cases, a computing system (e.g., the computing system 140) may instruct display of a virtual representation of the site model via a user interface.

The computing system can obtain location data identifying a location of a robot. In some embodiments, the computing system can obtain the location data from the robot (e.g., from a sensor of the robot). For example, the location data may identify a real-time and/or historical location of the robot. In some embodiments, the computing system can obtain the location data from a different system. For example, the location data may identify a location assigned to the robot.

The computing system may utilize the location data to identify a location of the robot. Based on identifying the location of the robot, the computing system may identify a site model associated with the location of the robot. The site model may include an image of the site (e.g., a two-dimensional image, a three-dimensional image, etc.). For example, the site model may include a blueprint, a graph, a map, etc. of the site associated with the location.

In some embodiments, to identify the site model, the computing system may access a site model data store. The site model data store may store one or more site models associated with a plurality of locations. Based on the location of the robot, the computing system may identify the site model associated with the location of the robot.

The site model may indicate a plurality of objects, entities, structures, or obstacles in the site of the robot. The plurality of objects, entities, structures, or obstacles may be areas within the site where the robot 410 may not traverse, may adjust navigation behavior prior to traversing, etc. based on determining the area is an obstacle. The plurality of objects, entities, structures, or obstacles may include static objects, entities, structures, or obstacles and/or dynamic objects, entities, structures, or obstacles. For example, the site model may identify one or more room(s), hallway(s), wall(s), stair(s), door(s), object(s), mover(s), etc. In some embodiments, the site model may identify objects, entities, structures, or obstacles that are affixed to, positioned on, etc. another obstacle. For example, the site model may identify an obstacle placed on a stair.

In the example of FIG. 5A, the site model identifies the site of the robot. The site model includes a plurality of areas (e.g., rooms). It will be understood that the plurality of objects, entities, structures, or obstacles may include more, less, or different objects, entities, structures, or obstacles.

FIG. 5B depicts a schematic view 500B of an annotated site model. In some cases, a computing system (e.g., the computing system 140) may instruct display of a virtual representation of the annotated site model via a user interface.

The annotated site model may include the site model (as described above) and one or more semantic labels. For example, the annotated site model may include one or more semantic labels of one or more objects, entities, structures, or obstacles in the site (e.g., rooms).

In some cases, to identify the annotated site model, the computing system may access a site model data store. The site model data store may store one or more annotated site models associated with a plurality of locations. Based on the location of the robot, the computing system may identify the annotated site model associated with the location of the robot.

In some cases, to identify the annotated site model, the computing system may provide the site model to a user computing device. For example, the computing system may instruct display of the site model via a user interface of the user computing device. The computing system may obtain the annotated site model from the user computing device in response to providing the site model to the user computing device. In some cases, the computing system may obtain one or more semantic labels from the user computing device and may generate the annotated site model based on the obtained one or more semantic labels.

In some cases, to identify the annotated site model, the computing system may access a machine learning model (e.g., implemented by the computing system or a separate system) and provide the site model to the machine learning model for annotation. For example, the computing system may provide the site model to a second computing system implementing the machine learning model and may obtain an output (e.g., the annotated site model) from the second computing system.

In the example of FIG. 5B, the annotated site model indicates the site of the robot. The annotated site model includes a plurality of objects, entities, structures, or obstacles that each correspond to a particular semantic label. A first area of the site corresponds to a first semantic label: “Bathroom,” a second area of the site corresponds to a second semantic label: “Storage,” a third area of the site corresponds to a third semantic label: “Charging Area,” a fourth area of the site corresponds to a fourth semantic label: “Unknown,” a fifth area of the site corresponds to a fifth semantic label: “Museum,” a sixth area of the site corresponds to a sixth semantic label: “Study,” a seventh area of the site corresponds to a seventh semantic label: “Hallway,” an eighth area of the site corresponds to an eighth semantic label: “Exit,” a first obstacle of the site corresponds to an ninth semantic label: “Couch,” a second obstacle of the site corresponds to a tenth label: “Boxes,” and a third obstacle of the site corresponds to an eleventh label: “Debris.” It will be understood that the plurality of objects, entities, structures, or obstacles may include more, less, or different objects, entities, structures, or obstacles and the semantic labels may correspond to more, less, or different semantic labels.

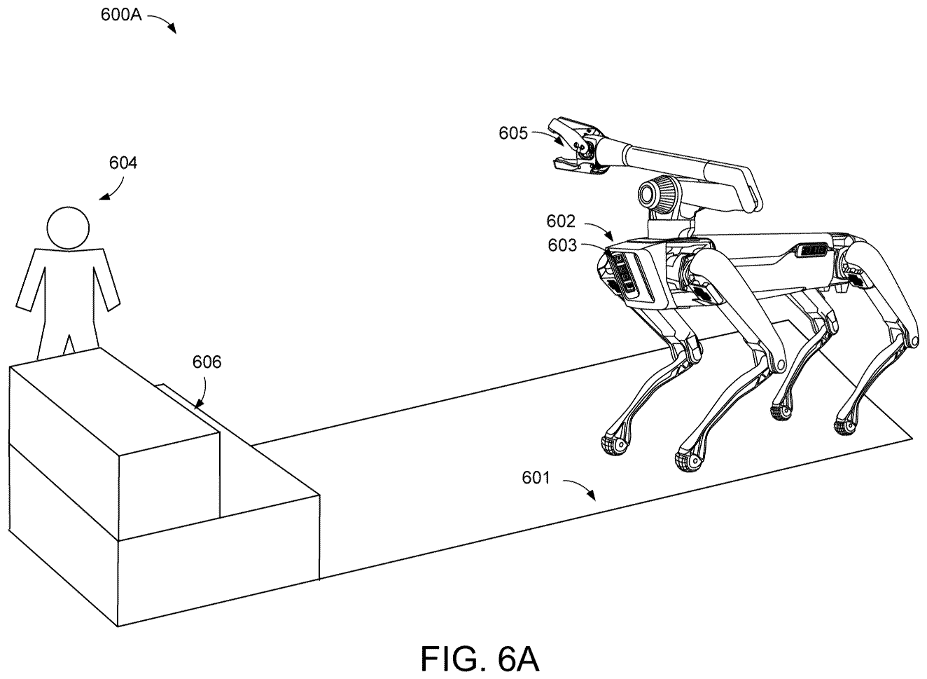

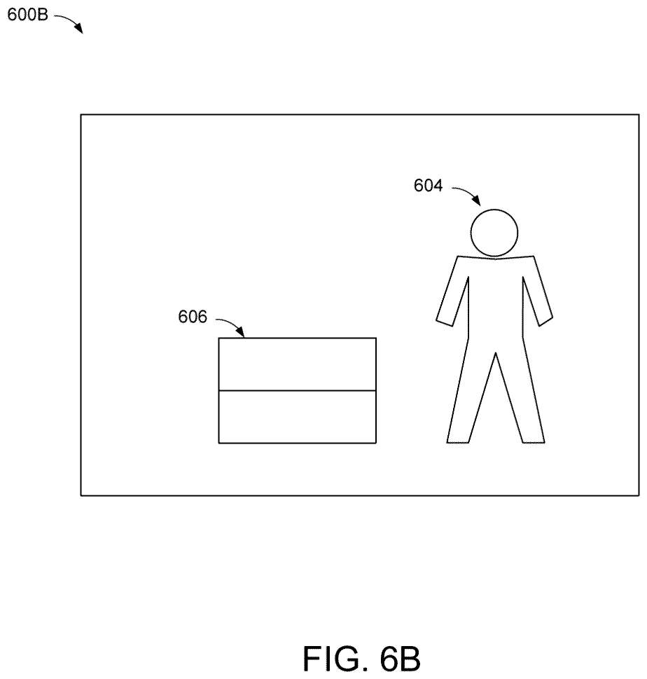

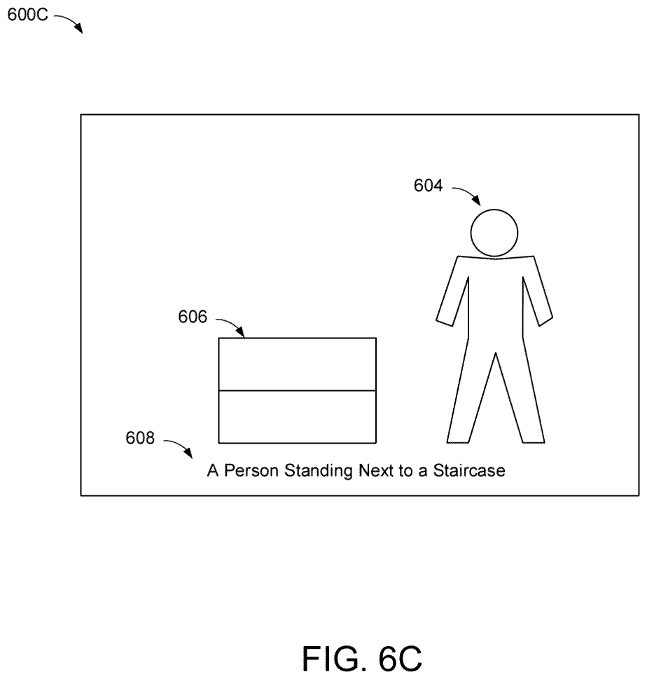

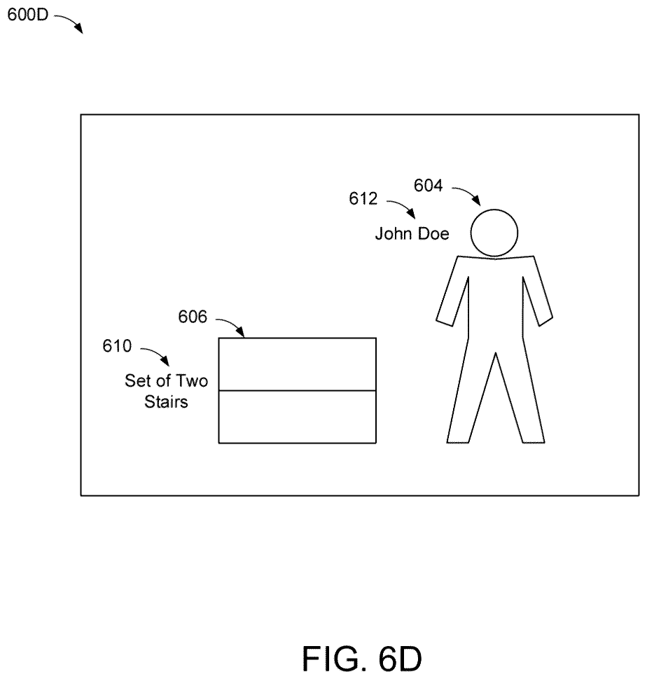

FIG. 6A shows a schematic view 600A of a robot 602 relative to an object 606 (e.g., a set of stairs) and an entity 604 (e.g., a person) located within a site 601 of the robot 602. In some embodiments, more, less, or different objects, entities, structures, or obstacles may be located within the site 601 of the robot 602.

The robot 602 may be or may include the robot 100 as described in FIG. 1A and FIG. 1B. For example, the robot 602 may be a legged robot. In the example of FIG. 6A, the robot 602 is a legged robot that includes four legs: a first leg (e.g., a right rear leg), a second leg (e.g., a left rear leg), a third leg (e.g., a right front leg), and a fourth leg (e.g., a left front leg).

The robot 602 further includes one or more first image sensors 603 associated with the front portion of the robot 602 (e.g., located on, located adjacent to, affixed to, etc. the front portion of the robot 602) and one or more second image sensors 605 associated with the hand member (e.g., located on, located adjacent to, affixed to, etc. the hand member). The robot 602 may include more, less, or different image sensors. For example, the robot 602 may include one or more image sensors associated with each side of the robot 602.

The robot 602 may be oriented relative to the object 606 and/or the entity 604 such that a front portion of the robot 602 faces the object 606 and/or the entity 604. For example, the robot 602 may be oriented such that all or a portion of the legs of the robot 602 form an angle with an open that opens towards the object 606 and/or the entity. In some cases, the robot 602 may be oriented relative to the object 606 and/or the entity 604 such that a side portion or a rear portion of the robot 602 faces the object 606 and/or the entity 604.

As discussed above, the object 606 may be a set of stairs (e.g., a staircase). In some cases, the object 606 may be a single stair, a box, a platform, all or a portion of a vehicle, a desk, a table, a ledge, etc.

As discussed above, the entity 604 may be a person. In some cases, the entity 604 may be another robot (e.g., another legged robot), an animal, etc.

A computing system (e.g., the computing system 140) may capture sensor data using the one or more first image sensors 603 and/or the one or more second image sensors 605. For example, the computing system may capture a first portion of the sensor data via the one or more first image sensors 603 and a second portion of the sensor data via the one or more second image sensors 605. In some cases, the computing system may capture the sensor data as the robot 602 traverses the site 601. For example, the computing system may capture the sensor data as the robot 602 moves toward the object 606 and/or the entity 604.

In some cases, the computing system may identify the object 606 and/or the entity 604 within the sensor data. In response to identifying the object 606 and/or the entity 604 within the sensor data, the computing system may obtain additional sensor data via the one or more first image sensors 603 and/or the one or more second image sensors 605.

To illustrate example sensor data obtained by the computing system, FIG. 6B depicts a schematic view 600B of sensor data. In some cases, a computing system (e.g., the computing system 140) may instruct display of a virtual representation of the sensor data via a user interface (of a user computing device). For example, as discussed below, the computing system may instruct display of a virtual representation of the sensor data to obtain annotated sensor data.

The sensor data may include image sensor data, lidar sensor data, ladar sensor data, etc. In the example of FIG. 6B, the sensor data includes image sensor data. For example, the sensor data may be an image of a scene within the site of the robot (e.g., robot 602). The sensor data may indicate a plurality of objects, entities, structures, or obstacles in the site of the robot. In the example of FIG. 6B, the sensor data indicates the object 606 and the entity 604.

The computing system can obtain location data identifying a location of a robot. For example, the computing system can obtain the location data in response to obtaining the sensor data. Further, the location data may indicate a location of the robot corresponding to the capture of the sensor data by one or more image sensors of the robot. In some embodiments, the computing system can obtain the location data from the robot (e.g., from a sensor of the robot). For example, the location data may identify a real-time and/or historical location of the robot. In some embodiments, the computing system can obtain the location data from a different system. For example, the location data may identify a location assigned to the robot.

The computing system may associate the location data with the sensor data based on determining that the location data indicates a location of the robot corresponding to the capture of the sensor data. Based on associating the location data with the sensor data, the computing system may store the location data and the associated sensor data in a sensor data store.

To illustrate how sensor data may be annotated, FIGS. 6C and 6D illustrate example annotated sensor data. FIG. 6C depicts a schematic view 600C of annotated sensor data. The schematic view 600C may include semantic labels associated with the sensor data as depicted in FIG. 6B. As discussed above, the annotated sensor data may include image sensor data, lidar sensor data, ladar sensor data, etc. and one or more semantic labels associated with the sensor data. In the example of FIG. 6C, the annotated sensor data includes image sensor data and one or more semantic labels. For example, the annotated sensor data may be an image of a scene within the site of the robot (e.g., robot 602). The annotated sensor data may indicate a plurality of objects, entities, structures, or obstacles in the site of the robot and one or more labels for all or a portion of the plurality of objects, entities, structures, or obstacles. In the example of FIG. 6C, the annotated sensor data indicates the object 606, the entity 604, and a semantic label 608: “A Person Standing Next to a Staircase.”

To obtain the annotated sensor data, a computing system (e.g., the computing system 140) may generate the annotated sensor data based on obtained sensor data. For example, the computing system may obtain sensor data via one or more sensors and may annotate the sensor data. Further, the computing system may implement a machine learning model to annotate the sensor data. For example, the computing system may provide the sensor data to a machine learning model trained to output one or more semantic labels and/or annotated sensor data based on provided sensor data.

In some cases, to obtain the annotated sensor data, the computing system may provide the sensor data to a second computing system (e.g., a user computing device). For example, the computing system may instruct display of a virtual representation of the annotated site model via a user interface of the user computing device. A user may interact with the user interface to annotate the sensor data. The user computing device may generate one or more semantic labels and/or annotated sensor data based on the user interactions. In some cases, the second computing system may implement a machine learning model to annotate the sensor data and the second computing system may provide one or more semantic labels and/or annotated sensor data (e.g., output by the machine learning model) to the computing system.

In the example of FIG. 6C, the annotated sensor data indicates the site of the robot. The annotated sensor data a plurality of objects, entities, structures, or obstacles that each correspond to a particular semantic label. In the example of FIG. 6C, the annotated sensor data includes an overall semantic label 608: “A Person Standing Next to a Staircase” corresponding to all or a portion of the objects, entities, structures, or obstacles within the annotated sensor data (e.g., object 606 and entity 604). It will be understood that the plurality of objects, entities, structures, or obstacles may include more, less, or different objects, entities, structures, or obstacles and the semantic label may correspond to more, less, or different semantic labels.

FIG. 6D depicts a schematic view 600D of annotated sensor data. The schematic view 600D may include semantic labels associated with the sensor data as depicted in FIG. 6B. The annotated sensor data may include image sensor data indicating a plurality of objects, structures, entities, and/or obstacles and one or more semantic labels. In the example of FIG. 6D, the plurality of objects, structures, entities, and/or obstacles includes the object 606 and the entity 604 and the annotated sensor data indicates the object 606, the entity 604, a first semantic label 610 for the object 606: “Set of Two Stairs,” and a second semantic label 612 for the entity 604: “John Doe.” It will be understood that the plurality of objects, entities, structures, or obstacles may include more, less, or different objects, entities, structures, or obstacles and the one or more semantic labels may correspond to more, less, or different semantic labels.

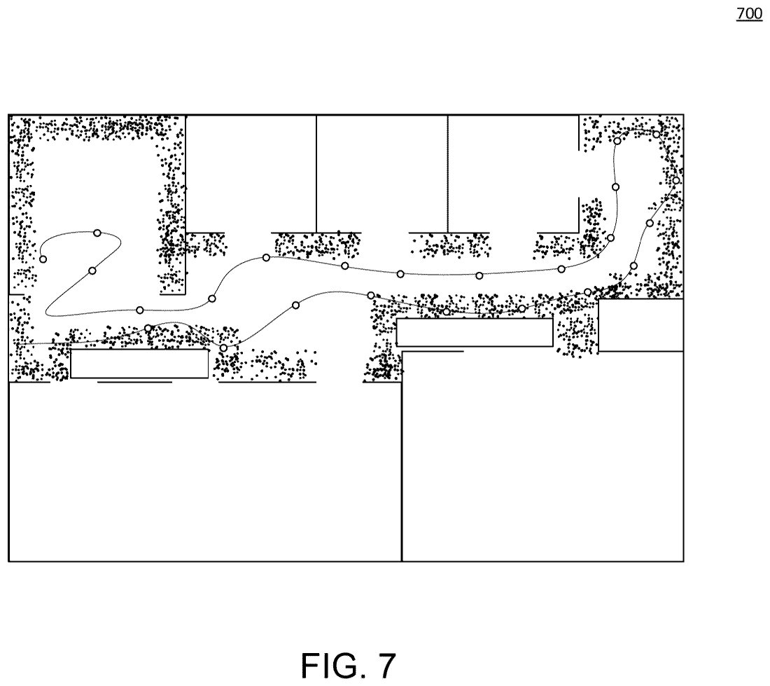

FIG. 7 depicts a schematic view 700 of a virtual representation of sensor data (including route data and point cloud data). For example, the schematic view 700 may be a virtual representation of sensor data overlaid on a site model associated with a site.

In some cases, a computing system (e.g., the computing system 140) may instruct display of a virtual representation of the sensor data via a user interface (of a user computing device). For example, as discussed below, the computing system may instruct display of a virtual representation of the sensor data to obtain annotated sensor data.

The computing system may identify route data associated with a robot. For example, the computing system may identify route data based on traversal of a site by the robot. In the example of FIG. 7, the route data includes a plurality of route waypoints and a plurality of route edges. For example, the route data includes a first route waypoint.

The computing system may further identify the point cloud data associated with the robot. For example, the computing system may identify point cloud data for all or a portion of the plurality of route waypoints.

In some cases, the computing system may combine (e.g., collate) the sensor data with the site model. To combine the sensor data with the site model, the computing system may identify location data associated with the robot. For example, the location data may identify a location of a route identified by the route data. In some embodiments, the location data may identify a location of the robot during generation and/or mapping of the route data. Based on the location data, the computing system may identify a site model associated with the site.

The computing system may overlay the sensor data (e.g., the route data and the point cloud data) over the site model based on identifying the site model and the sensor data. For example, the computing system may overlay the sensor data over the site model and provide the sensor data overlaid over the site model as sensor data for annotation.

The computing system may utilize the sensor data and/or the sensor data overlaid on the site model to obtain annotated sensor data. As discussed above, to obtain the annotated sensor data, a computing system (e.g., the computing system 140) may generate the annotated sensor data based on the sensor data and/or the sensor data overlaid on the site model (e.g., using a machine learning model). In some cases, to obtain the annotated sensor data, the computing system may provide the sensor data and/or the sensor data overlaid on the site model to a second computing system (e.g., a user computing device). For example, the computing system may instruct display of a virtual representation of the sensor data and/or the sensor data overlaid on the site model via a user interface of the user computing device. A user may interact with the user interface to annotate the sensor data and/or the sensor data overlaid on the site model.

In some cases, the computing system may not separately obtain annotated sensor data and an annotated site model. For example, as discussed above, the computing system may overlay the sensor data on the site model and may provide the sensor data overlaid on the site model for annotation. Based on providing the sensor data overlaid on the site model for annotation, the computing system may obtain annotated data, may transform the annotated data, and may utilize the transformed data to identify one or more actions for the robot.

Based on the annotated data (e.g., the annotated sensor data and/or the annotated site model), as discussed above, the computing system may transform the annotated data. For example, the computing system may transform (e.g., normalize) the annotated data from a first data format (or a first data format and a second data format) to a third data format.

The computing system may identify an action for a robot based on the transformed data. In some cases, the computing system may provide the transformed data to a second computing system and the second computing system may provide an action (e.g., an identifier of an action) to the computing system. For example, the second computing system may implement a machine learning model, provide the transformed data to the machine learning model, obtain an output of the machine learning model indicative of an action, and provide the output to the computing system.

The action may include one or more movements and/or data for output by the robot. For example, the action may include one or more movements of an appendage (e.g., an arm, a hand member, a leg, etc.) of the robot. In another example, the action may include audio data for output by the robot.

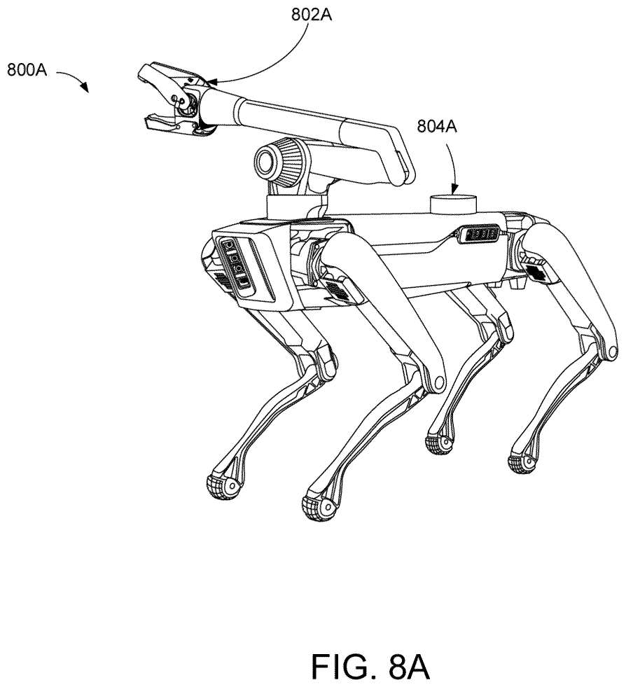

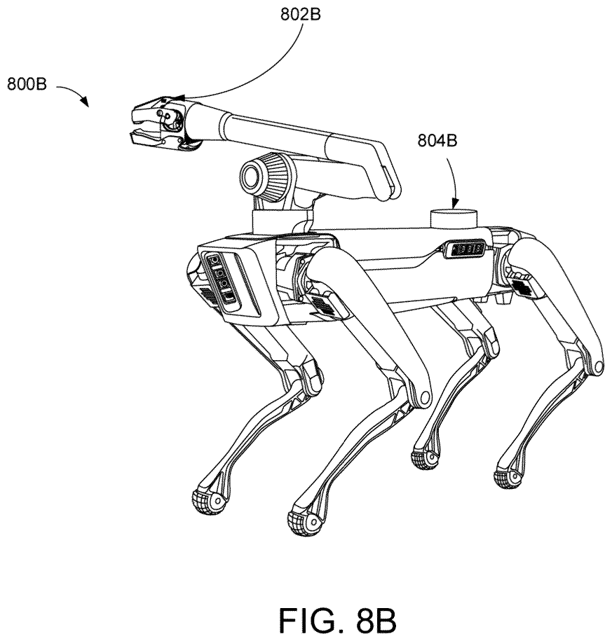

To illustrate examples actions to be implemented by a robot, FIG. 8A depicts a robot 800A (e.g., a legged robot). The robot 800A may include and/or may be similar to the robot 100 discussed above with reference to FIGS. 1A and 1B. The robot 800A may include a body, one or more legs coupled to the body, an arm coupled to the body, and an interface. The interface may include a display (e.g., a graphical user interface, a speaker, etc.). For example, the display may be a speaker, a microphone (e.g., a ring array microphone), and one or more light sources (e.g., light emitting diodes). In the example of FIG. 8A, the robot 800A is a quadruped robot with four legs.

As discussed above, a computing system may obtain sensor data and a site model. For example, the computing system may obtain the sensor data via one or more first sensors of the robot 800A and the site model via one or more second sensors of the robot 800A.

The computing system may transform the sensor data and/or the site model to generate transformed data. For example, the computing system may combine transformed sensor data and a transformed site model to generate the transformed data. The computing system may identify an action based on the transformed data.

In some cases, the computing system may identify the action based on prompt data. For example, as discussed above, the computing system may obtain the prompt data from a second computing system (e.g., a user computing device). The prompt data may include an action identifier, an entity identifier, and/or a persona. For example, the action identifier may indicate an action to be performed by the robot, the entity identifier may indicate an entity within a site of the robot, and the persona may indicate a persona of the robot.

The computing system may customize the action based on the action identifier of the prompt data. For example, the action identifier may include an action requested to be performed by the robot 800A and the computing system may identify an action based on the action requested to be performed by the robot 800A. In some cases, the computing system may identify an action for performance that is different from the action requested to be performed by the robot 800A. For example, the action requested to be performed by the robot 800A may include a navigation action (e.g., navigate to a particular location) and the computing system may adjust the navigation action (e.g., based on sensor data, a site model, the entity identifier, a persona, etc.).

The computing system may customize the action based on the entity identifier of the prompt data. For example, the entity identifier may indicate an entity within the site (e.g., John Doe, James Smith, User #1, etc.) and the computing system may identify an action based on the entity. In another example, the entity identifier may indicate a job (e.g., engineer, linguist, art critic, investor, etc.), a role (e.g., navigator, guest, documenter, etc.), an age (e.g., an adult, a child, etc.), an experience (e.g., an roboticist with 15 years of experience, a guest with limited experience with robots, etc.), a personality or emotion (e.g., impatient, happy, sad, disinterested, captivated, etc.), an object (e.g., the entity is holding a camera, is wearing a work badge, is wearing a suit, etc.), etc. associated with the entity. In some cases, the computing system may generate and/or adjust the entity identifier based on sensor data. For example, the computing system may determine that a particular entity is disinterested, happy, etc. based on sensor data and may adjust the entity identifier. In another example, the computing system may obtain sensor data based on scanning a badge of an entity, may identify data associated with the entity based on the sensor data, and may adjust the entity identifier.

In some cases, the computing system may identify communication parameters (e.g., indicating how to communicate with the entity) based on the entity (and the identifier) and may identify the action based on the communication parameters. The one or more communication parameters may include a particular persona, a particular language, a particular dialect, a particular background, a particular audio speed, a particular audio tempo, a particular tone, a particular preferred terminology, etc. For example, the action requested to be performed by the robot 800A may include a navigation action (e.g., navigate to a particular location) and the computing system may adjust the navigation action based on the entity identifier (e.g., based on the communication parameters). In another example, the action requested to be performed by the robot 800A may be a guide action (e.g., guide an entity through an environment) and the computing system may adjust the guide action based on the entity identifier (e.g., based on the communication parameters). For example, the computing system may adjust the guide action to reduce the amount of audio or decrease a duration of the guide action if the entity is disinterested or if the entity is an adult, to increase an amount of audio or increase a duration of the guide action if the entity is interested or if the entity is a child, to guide an entity to or through a portion of the environment that includes particular objects if the entity has experience with or expressed an interest in the particular objects, to adjust the terminology and/or language utilized by the robot if the entity is an adult, if the entity is a child, or if the experience has or lacks particular experience, etc.

The computing system may customize the action based on a particular persona (e.g., an energetic persona, an upbeat persona, an enthusiastic persona, or a snarky persona) of the prompt data. The persona may include a time-based persona, location based persona, an entity based persona, an emotion based persona, etc. associated with the robot 800A. For example, the computing system may identify a persona based on a time period, a location, an entity, an emotion, etc. associated with the robot 800A. For example, the action requested to be performed by the robot 800A may include a navigation action (e.g., navigate to a particular location) and the computing system may adjust the navigation action based on the persona.

The action may be to communicate with the object, obstacle, entity, or structure (e.g., by outputting an alert, causing display of a user interface, implementing a physical gesture, etc.) when the feature is classified as a mover that is capable of interpreting the communications (e.g., another robot, a smart vehicle, an animal, a person, etc.). For example, the alert may include text data (e.g., text data including “Hello,” “Excuse Me,” “I am Navigating to Destination X,” “I am performing Task X,” “Welcome to the Museum,” etc.), image data (e.g., image data including a video providing background on the robot 800A, an image of an organization associated with the robot 800A, etc.), audio data (e.g., a horn sound, an alarm sound, audio data including “Hello,” “Excuse Me,” “I am Navigating to Destination X,” “I am performing Task X,” “Welcome to the Museum,” etc.), etc.

In the example of FIG. 8A, the action may include one or more movements 802A and/or an output 804A. For example, the one or more movements 802A can include one or more movements of the arm and the output 804A can include text, audio, an image, etc. to be output via the interface. In the example of FIG. 8A, the one or more movements 802A include an opening of the hand member of the arm and the output 804A includes an output via the interface (e.g., an audio output, a text output, an image output, etc.).

The computing system may synchronize the one or more movements 802A and the output 804A to be output via the interface. Further, the computing system may synchronize the one or more movements 802A and the output 804A to be output via the interface such that the robot 800A appears to be speaking the output 804A (e.g., the audio and/or the text). For example, the computing system may synchronize one or more movements 802A of the arm (e.g., the hand member of the arm) and audio to be output by the interface such that the arm (via the hand member) appears to be speaking the audio based on movement of a mouth (e.g., a human mouth) when speaking. In another example, the computing system may synchronize one or more movements 802A of the arm and text to be output (e.g., displayed) by the interface such that as the text is output by the interface, the arm (via the hand member) appears to be speaking the text based on movement of a mouth (e.g., a human mouth) when speaking.

FIG. 8B depicts a robot 800B (e.g., a legged robot). The robot 800B may include and/or may be similar to the robot 100 discussed above with reference to FIGS. 1A and 1B. The robot 800B may include a body, one or more legs coupled to the body, an arm coupled to the body, and an interface. The interface may include a display (e.g., a graphical user interface, a speaker, etc.). In the example of FIG. 8B, the robot 800B is a quadruped robot with four legs.

FIG. 8B may illustrate an action implemented after the action illustrated by FIG. 8A. For example, FIG. 8A may illustrate a first action and FIG. 8B may illustrate a second action implemented subsequent to the first action. In the example of FIG. 8B, the action may include one or more movements 802B and/or an output 804B. For example, the one or more movements 802B can include one or more movements of the arm and the output 804B can include text, audio, an image, etc. to be output via the interface. In the example of FIG. 8B, the one or more movements 802B include a closing of the hand member of the arm and the output 804B includes an output via the interface (e.g., an audio output, a text output, an image output, etc.).

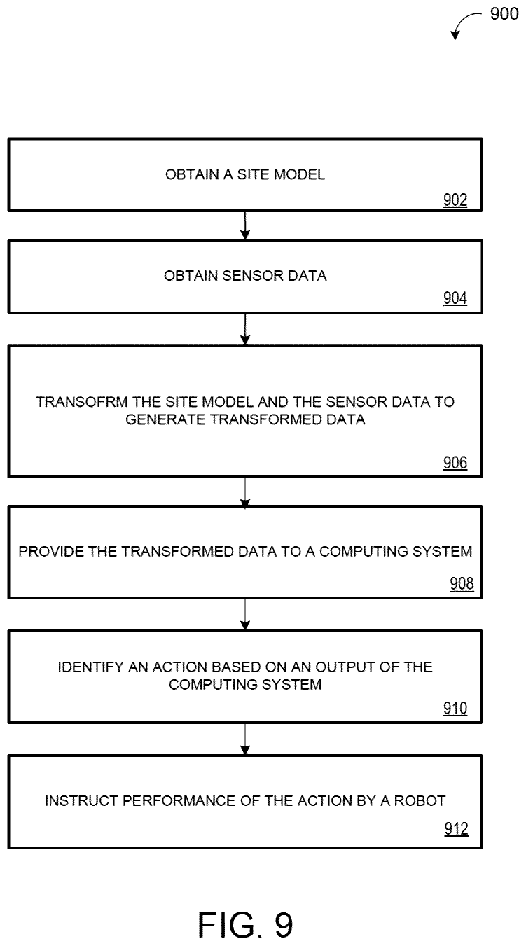

FIG. 9 shows a method 900 executed by a computing system to operate a robot (e.g., by instructing performance of an action) based on data associated with the robot (e.g., sensor data and/or a site model), according to some examples of the disclosed technologies. For example, the robot (e.g., a mobile robot) may be a legged robot with a plurality of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the sensor system 130, the computing system 140, the control system 170, the site model system 402, and/or the data transformation system 404 as discussed above, and may include memory and/or data processing hardware.

The computing system may be grounded based on the site of the robot. For example, the computing system may utilize data grounded in the sensor data associated with the site, the site model associated with the site, and the prompt data to identify one or more actions to perform.

The robot may include one or more audio sources (e.g., one or more different audio sources). For example, the robot may include a buzzer, a resonator, a speaker, etc. In some cases, the robot may include a transducer (e.g., piezo transducer). For example, the transducer may be affixed to the body of the robot. The computing system may utilize the transducer to cause the body of the robot to resonate and output audio (e.g., a sound).

In some cases, the method 900 may be initiated based on obtained sensor data (e.g., audio data). The computing system may obtain sensor data and provide the sensor data to a second computing system to transform the sensor data (e.g., normalize the sensor data). For example, the second computing system may transform the sensor data from an audio data format to a text data format. Based on providing the sensor data to the second computing system, the computing system may obtain transformed sensor data (e.g., transformed audio data) from the second computing system.

In some cases, the computing system may interrupt the robot based on obtained sensor data. The computing system may interrupt the robot in response to an input from a user (identified within the sensor data) thereby enabling the user (or any other entity including entities not located in the immediate environment (e.g., a particular vicinity, proximity, etc.) of the robot) to interrupt the robot. The computing system may determine one or more interrupts that may include and/or may be based on audio, image frames, or other inputs. For example, the one or more interrupts may include a particular wake word or wake phrase (e.g., “pause,” “stop,” “hey spot,” “question,” “spot,” etc.), a particular image frame (e.g., a user providing an X shape with their hands, a user providing a thumbs down, a user frowning, etc.), a physical input (e.g., a button press), an input from another computing device (e.g., an interaction by the user with a user interface provided by a user computing device), etc. In some cases, the computing system may obtain data identifying the one or more interrupts. For example, a user computing device may provide the data identifying the one or more interrupts (e.g., the one or more interrupts may be customizable by a user). In some cases, the computing system may generate the data identifying the one or more interrupts.

The computing system may compare the obtained sensor data to the one or more interrupts. For example, the computing system may compare the obtained sensor data to determine whether the obtained sensor data includes an interrupt of the one or more interrupts. Based on the computing system determining that the obtained sensor data and/or the transformed sensor data corresponds to a particular interrupt (e.g., a wake phrase, a wake word, etc.), the computing system may pause, delay, or interrupt performance of one or more actions by the robot.

To interrupt the robot, based on determining that the obtained sensor data and/or the transformed sensor data corresponds to a particular interrupt, the computing system may instruct performance (e.g., scheduled performance, current performance, etc.) of one or more actions by the robot to be paused, interrupted, delayed, etc. (e.g., the computing system can interrupt actions currently being performed by the robot and/or scheduled to be performed by the robot). In some cases, based on determining that the obtained sensor data and/or the transformed sensor data corresponds to a particular interrupt, the computing system may suppress second audio data (e.g., output by the robot) and/or pause movement of the robot. For example, the computing system may suppress the second audio data and/or pause movement of the robot to enable the robot to obtain the sensor data (e.g., at block 904).

Further, based on the computing system determining that the obtained sensor data and/or the transformed sensor data corresponds to a particular interrupt (e.g., a wake phrase, a wake word, etc.), the computing system may instruct the robot to obtain additional sensor data (e.g., additional audio data). In some cases, the computing system may instruct the robot to provide an output (e.g., a light output via one or more light sources) indicating that the robot is obtaining additional sensor data (e.g., is listening for additional audio data). For example, the computing system may instruct the robot to activate a circular array of light sources on the robot such that the circular array of light sources output light (e.g., flashing light, spinning light, etc.). In some cases, based on determining that the obtained sensor data and/or the transformed sensor data corresponds to a particular interrupt, the computing system may implement method 900 (e.g., obtain a site model, obtain sensor data, transform the site model and the sensor data, etc.). For example, the additional sensor data obtained by the robot may be the sensor data obtained by the robot at block 904.

At block 902, the computing system obtains a site model. For example, the site model may be associated with a site of a robot (e.g., an environment). The site model may include one or more of two-dimensional image data or three-dimensional image data. Further, the site model may include one or more of site data, map data, blueprint data, environment data, model data, or graph data. Further, the site model may include a blueprint, a map, a model (e.g., a CAD model), a floor plan, a facilities representation, a geo-spatial map, and/or a graph and/or the site model may include an image and/or virtual representation of the blueprint, the map, the model, the floor plan, the facilities representation, the geo-spatial map, and/or the graph.

The site model may be associated with a first data format (e.g., in a first data format, having a first data format, etc.), a first processing status, and/or a first data type. In some cases, at least a portion of the site model be associated with the first data format, the first processing status, and/or the first data type. For example, at least a portion of the site model may be unprocessed image data in a first image data format and having a particular data type.

The computing system may obtain the site model from a first data source (e.g., a computing system located remotely from the robot). For example, the computing system may obtain the site model from a user computing device.

At block 904, the computing system obtains sensor data associated with a robot. The computing system may obtain the sensor data from one or more components (e.g., sensors) of the robot. For example, the sensor data may include image data, lidar data, ladar data, radar data, pressure data, acceleration data, battery data (e.g., voltage data), speed data, position data, orientation data, pose data, tilt data, roll data, yaw data, ambient light data, ambient sound data, time data, etc. The computing system can obtain the sensor data from an image sensor, a lidar sensor, a ladar sensor, a radar sensor, pressure sensor, an accelerometer, a battery sensor, a speed sensor, a position sensor, an orientation sensor, a pose sensor, a tilt sensor, a light sensor, and/or any other component of the robot. Further, the computing system may obtain the sensor data from a sensor located on the robot and/or from a sensor located separately from the robot.

In one example, the sensor data may include audio data associated with a component of the robot. For example, the sensor data may be indicative of audio output by one or more components of the robot.

The sensor data may include sensor data associated with the site. For example, the computing system may identify features associated with the site based on the sensor data. In some cases, the sensor data may include or may be associated with route data. For example, the sensor data can include a map of the site indicating one or more of an obstacle, structure, corner, intersection, path of a robot, path of a person, etc. in the site.

The sensor data may be associated with a second data format (e.g., in a second data format, having a second data format, etc.), a second processing status, and/or a second data type. In some cases, at least a portion of the sensor data be associated with the second data format, the second processing status, and/or the second data type. For example, at least a portion of the sensor data may be processed image data and/or point cloud data in a second image data format and having a particular data type. Further, the first data format may be different from the second data format, the first processing status may be different from the second processing status, and/or the first data type may be different from the second data type.

The computing system may obtain the sensor data from a second data source (e.g., different as compared to the first data source). For example, the computing system may obtain the sensor data from a sensor of the robot.

The sensor data and/or the site model may be captured based on movement of the robot along a route through the site. For example, the robot may move along a route through the site and obtain sensor data based on the movement.

In some cases, the site model and/or the sensor data may be annotated with one or more semantic labels (e.g., one or more captions associated with the site model and/or the sensor data). For example, the site model may be an annotated site model and/or the sensor data may be annotated sensor data. The one or more semantic labels may indicate labels for one or more objects, structures, entities, or obstacles in the site of the robot.

The site model and/or the sensor data may be annotated by a separate computing system (e.g., a user computing device, a second computing system, etc.) or the computing system. For example, the computing system may provide (e.g., to a user computing device, to a computing system implementing a machine learning model, to a machine learning model, etc.) the site model and/or the sensor data for annotation. Based on providing the site model and/or the sensor data for annotation, the computing system may obtain the annotated site model and/or the annotated sensor data.

In some cases, to annotate the site model and/or the sensor data, the computing system may detect (e.g., identify and classify) one or more features of the site (e.g., as corresponding to a particular entity, obstacle, object, or structure) based on the data. For example, the computing system may annotate the site model and/or the sensor data with a location of the feature, a classification of the feature (e.g., as corresponding to a particular entity, object, obstacle, structure, etc.), an action associated with the feature (e.g., a particular entity is talking, walking, moving away, etc.), etc. Further, the computing system may annotate the site model and/or the sensor data using image captioning and/or visual question answering (e.g., the visual question being “what is interesting about the image data?”).

At block 906, the computing system transforms the site model and the sensor data to generate transformed data. The computing system may transform the site model and the sensor data to generate transformed data associated with a third data format (e.g., in a third data format, having a third data format, etc.), a third processing status, and/or a third data type. For example, the third data format may be a text data format.

The computing system may transform the site model from the first data format to the third data format to obtain a transformed site model and may transform the sensor data from the second data format to the third data format to obtain transformed sensor data. Further, the computing system may combine (e.g., adjoin, append, join, link, collate, concatenate, etc.) the transformed site model and the transformed sensor data to obtain the transformed data.

In some cases, the computing system may transform the annotated site model and/or the annotated sensor data. For example, the computing system may transform the annotated sensor data and the site model. In another example, the computing system may transform the sensor data and an annotated site model.

In some cases, the computing system may transform the site model and/or the sensor data by annotating the site model and/or the sensor data. In some cases, the computing system may transform the site model and/or the sensor data by identifying semantic labels (e.g., semantic tokens) within the site model (e.g., the annotated site model) and the sensor data (e.g., the annotated sensor data) and generating a transformed site model that includes semantic labels from the site model and excludes other data from the site model (e.g., non-text based data) and transformed sensor data that includes semantic labels from the sensor data and excludes other data from the sensor data (e.g., non-text based data).

To transform the site model and/or the sensor data, the computing system may obtain textual data (e.g., based on semantic labels) associated with the site model and/or the sensor data. The computing system may process the textual data to generate the transformed data. The computing system may generate the transformed data based on a language (e.g., the syntax, schematics, functions, commands, keywords, operators, etc. of the language). For example, the transformed data (e.g., semantic tokens of the transformed data) may include functions, keywords, operators (e.g., =), etc. according to the language (e.g., Python) based on a library associated with the language. In some cases, the computing system may obtain and/or access the library to generate the transformed data. In one example of the transformed data, the transformed data may be or may include: “state={‘curr_location_id’: ‘home’, ‘location_description’: ‘home base. There is a dock here.’, ‘nearby_locations’: [‘home’, ‘left_side’, ‘under_the_stairs’], ‘robot_sees’: ‘a warehouse with yellow robots with lines on the floor.’, ‘nearby_people’ [John Doe, Unknown Person 245]′}.”

At block 908, the computing system provides the transformed data to a computing system (e.g., a second computing system, a remote computing system, a separate computing system, the computing system, etc.). For example, a second computing system (e.g., located separately or remotely from the computing system) may implement a machine learning model (e.g., a large language model that generates an output using a transformer architecture) and the second computing system may obtain the transformed data and provide the transformed data to the computing system. In some cases, the computing system may provide the transformed data directly to a machine learning model.

In some cases, the computing system may not provide the transformed data to a second computing system. Instead, the computing system may implement a machine learning model and may provide the transformed data to the machine learning model implemented by the computing system (e.g., implemented by data processing hardware of the computing system).

The computing system may obtain prompt data (e.g., including an entity identifier, an action identifier, a persona, etc.). For example, the computing system may obtain the prompt data as input (e.g., indicative of an entity, an action, a persona, etc.). The computing system may provide the prompt data with the transformed data to the second computing system. In some cases, the computing system may generate a prompt based on the transformed data and/or the prompt data and provide the generated prompt to the machine learning model (e.g., via the second computing system).

The computing system may identify the entity identifier (e.g., identifying a particular entity such as John Doe), the action identifier (e.g., identifying a particular action such as a guide action to guide an entity through the site), and/or the persona (e.g., a character description, a character goal, a character phrase, etc.) associated with the robot (e.g., of the robot) based on the prompt data.

In some cases, the prompt data may include a request, command, instruction, etc. (e.g., for a machine learning model) to generate an output indicative of a particular action. Further, the prompt data may include a request (e.g., to be concise) for the machine learning model.

The computing system may obtain the prompt data according to (e.g., in) a particular language (e.g., a computer language, a programming language, a processing language, etc.). For example, the language may be Python, Java, C++, Ruby, etc. The computing system may obtain the prompt data in the particular language and/or may adjust the prompt data to confirm to the particular language. For example, the prompt data may include textual data that conforms to a programming language (e.g., the syntax, semantics, format, etc. of the programming language).

The prompt data may include textual data (e.g., a script, comments, notes, commentary, etc.) according to the language. For example, the prompt data may include textual data according to the syntax, semantics, format, etc. according to Python. In one example, the prompt data may be:
#Tour Guide API.
#Use the Tour Guide API to guide guests through a building using
#a robot. Tell the guests about what you see, and make up interesting stories
#about it. Persona: “You are a snarky, sarcastic robot who is unhelpful.”

In the above example, the prompt data may indicate a guide action (including a story telling action and a sight based action) and snarky, sarcastic persona (including the indication that the robot is to be unhelpful) for the robot.

In some cases, the computing system may generate the transformed data, annotate the site model, annotate the sensor data, etc. based on the prompt data. For example, the prompt data may indicate that the robot is to describe a scene. Based on the prompt data, the computing system may generate transformed data (e.g., one or more semantic tokens) that describe the scene. Further, the computing system may annotate the site model and/or the sensor data based on the prompt data (e.g., annotate sensor data to describe the scene based on the prompt data).

In some cases, the computing system may obtain the prompt data via a user computing device, a second computing system (e.g., implementing a machine learning model), a machine learning model, etc. For example, the computing system may obtain instructions indicating at least a portion of the prompt data (e.g., a persona assigned to the robot) from a user computing device. To facilitate input of the prompt data, the computing system may provide an identifier of a language to the user computing device, the second computing system, the machine learning model, etc. For example, the computing system may provide an output indicating that the prompt data is to be provided according to the identifier of the language.

In some cases, the computing system may generate the prompt data based on sensor data (e.g., audio data associated with audio instructions indicative of a requested action, image data indicating an entity in an environment of the robot, etc.).

In some cases, the computing system may determine that a second computing system (e.g., the robot, the computing system providing the output based on transformed data and the prompt data, etc.) may operate on input according to a particular language. Based on determining that the second computing system may operate on input according to the particular language, the computing system may provide the identifier of the particular language to a third computing system and request prompt data according to the particular language.

The prompt data and the transformed data may correspond to the same language. For example, the prompt data and the transformed data may correspond to Python. In some cases, the computing system may convert the prompt data and the transformed data such that the prompt data and the transformed data correspond to the same particular language thereby enabling another computing system to understand the prompt data and the transformed data. Further, the computing system may verify whether the prompt data and/or the transformed data is formatted according to a particular language and convert the prompt data and/or the transformed data if the computing system determines that the prompt data and/or the transformed data is not formatted according to the particular language.

Based on the transformed data and/or the prompt data, the computing system may generate a prompt (e.g., engineered using prompt engineering). For example, the computing system may perform prompt engineering. In some cases, the prompt may be and/or may include a prompt for a machine learning model to provide an output as if the machine learning model were writing a next line in a script (e.g., a script according to a particular language such as Python) based on an input corresponding to the script. In some cases, the prompt may be and/or may include a prompt to limit the size, amount, length, etc. of the output of the machine learning model (e.g., a prompt to be concise). To provide the transformed data to the second computing system, the computing system may provide the transformed data as part of the prompt.

The persona of the robot may include an emotion based persona, a time period based persona, a location based persona, an entity based persona, etc. For example, the persona of the robot may be an energetic persona, an upbeat persona, a happy persona, a professional persona, a disinterested persona, a quiet persona, a boisterous persona, an aggressive persona, a competitive persona, an achievement-oriented persona, a stressed persona, a counseling persona, an investigative persona, a social persona, a realistic persona, an artistic persona, a conversational persona, an enterprising persona, an enthusiastic persona, an excited persona, a snarky persona (e.g., a sarcastic persona), etc. In another example, the persona of the robot may be a tour guide persona, an explorer persona, a receptionist persona, a teacher persona, a companion persona, an entertainer persona, etc. In another example, the persona of the robot may be a 1920's based persona, a 1970's based persona, a 1600's based persona, etc. In another example, the persona of the robot may be a southeastern United States based persona, a northern England based persona, etc.

In some cases, the computing system may provide a plurality of personas for selection of a persona, a plurality of action identifiers for selection of an action identifier, and/or a plurality of entity identifiers for selection of an entity identifier. For example, the computing system may instruct display of a user interface via a user computing device that provides a plurality of personas for selection, a plurality of entity identifiers for selection, and/or a plurality of action identifiers for selection. The computing system may obtain a selection of a persona of the plurality of personas, a selection of an action identifier of the plurality of action identifiers, and/or a selection of an entity identifier of the plurality of entity identifiers (e.g., from a user computing device).

In some cases, the computing system may obtain an output of a machine learning model (e.g., implemented by the computing system or a different computing system and based on the sensor data, the site model, second sensor data, etc.) as an input to the computing system (e.g., indicative of an action). For example, the output may be based on an entity within the site of the robot. Based on the output of the machine learning model, the computing system may identify a persona of the robot.

At block 910, the computing system identifies an action based on an output of the computing system (e.g., the second computing system, the remote computing system, the separate computing system, the computing system, etc.). For example, the computing system may obtain an output of a second computing system from the second computing system and identify an action based on the output in response to providing the transformed data to the second computing system. The action may be based on the transformed data.

The action may be an audio based action, a navigation action, etc. For example, the action may be indicative of audio (e.g., audio output, audio data, audio data output, etc.) and/or a movement of the robot.

In some cases, the output of the computing system may indicate a text based action (e.g., the output may be a string of text.) The computing system may include a text-to-audio component (e.g., a text-to-speech system) that converts text data of the output (e.g., a string of text) into audio for output by the computing system.

In some cases, the computing system may not obtain an output of a second computing system. Instead, the computing system may obtain the output from a component of the computing system.

The action may be based on the prompt data (e.g., may be identified based on the prompt data, may be generated based on the prompt data, etc.). For example, the computing system may provide the prompt data with the transformed data to the computing system and the output and/or the action may be based on the transformed data and/or the prompt data (e.g., one or more semantic tokens of the transformed data and/or one or more comments of the prompt data).

The output of the computing system may include functions (e.g., Python functions) according to a language (e.g., Python). For example, the output of the computing system may be based on the syntax, statements, parameters, schematics, functions, commands (e.g., move, say, etc.), operators (e.g., =), expressions, keywords, etc. of the language. In some cases, the output of the computing system may be one or more semantic labels (e.g., semantic tokens) according to a particular language. For example, the computing system may generate one or more second semantic tokens based on one or more first semantic tokens of the transformed data and one or more comments of the prompt data according to Python. In another example, the output of the computing system may be or may include: “say (′Hello, my name is Robot 239! Can I ask your name?′, target=Unknown Person 245).”

To identify the action, the computing system may convert the output of the computing system (e.g., the one or more semantic tokens) into the action. For example, the computing system may convert the one or more semantic labels into an action in a language (e.g., format) that the robot can understand and implement (e.g., point a hand member at Unknown Person 245 and ask their name).

At block 912, the computing system instructs performance of the action by a robot (e.g., the robot, a different robot, etc.). To instruct performance of the action, the computing system may instruct output of the audio (e.g., audio output, audio data, audio data output, etc.) and/or the robot to move according to the movement (e.g., an arm, a leg, etc. of the robot to move). For example, the computing system may instruct output of the audio via a speaker of the robot.

The audio may include a question or a phrase. For example, the audio may include a request to provide an entity identifier (e.g., a name of an entity) based on the computing system identifying an entity located within the site. Based on the audio, the computing system may obtain sensor data (e.g., audio data indicative of an entity identifier) and may assign an entity identifier to an entity within the site based on the audio data. Based on the entity identifier, the computing system may identify one or more communication parameters. The one or more communication parameters may include a particular persona, a particular language, a particular dialect, a particular background, a particular audio speed, a particular audio tempo, a particular preferred terminology, etc. The computing system may store the entity identifier (and/or the communication parameters) as prompt data. Further, the computing system may instruct output of audio data (e.g., directed to the entity) according to the prompt data (e.g., the one or more communication parameters) based on identifying the entity. In another example, the audio may provide information associated with the site.

In some cases, the computing system may determine and/or identify an entity within the site of the robot (e.g., an entity located closest to the robot as compared to other entities within the site). For example, the computing system may sensor data (e.g., audio data, image data, etc.) and identify a location, presence, orientation, etc. of the entity within the site. Performance of the action may cause the robot to orient at least a portion of the robot (e.g., a hand member of the robot) in a direction towards (e.g., facing) the entity. Based on orienting at least a portion of the robot in a direction towards the entity, performance of the action may cause the robot to output the audio.

Further, performance of the action may cause simultaneous performance of movement(s) of the robot and output of audio (e.g., identified by the action) such that the robot (or a portion of the robot) appears to be speaking. Further, the computing system may synchronize the audio to the movement(s) of the robot to obtain synchronized audio and synchronized movement(s). The computing system may instruct performance of the synchronized movement(s) and output of the synchronized audio by the robot.

As discussed above, in some cases, the action may be or may include audio (e.g., an audible alert, an output indicative of an audible alert, etc.). In some cases, a user computing device may provide an input to the computing system identifying the audio (e.g., a message, a warning, etc.). For example, the audio may include audio provided by the user computing device. The computing system may identify the audio and instruct output of the audio via an audio source (e.g., a speaker) of the robot. For example, the computing system may instruct output of the output using a speaker and the speaker output the audible alert.

In some cases, the computing system may instruct performance of multiple actions. For example, the computing system may determine an action performed by the robot based on instructing performance of the action (e.g., a variance between the action instructed to be performed and the action performed). The computing system may identify a third action for performance based on providing second transformed data (e.g., a second transformed site model, second transformed sensor data, etc.), second prompt data, the sensor data, an identifier of the second action, and the site model to a computing system (e.g., the second computing system, the remote computing system, the separate computing system, the computing system, etc.). The computing system may instruct performance of the third action by the robot.

In some cases, the computing system may instruct partial performance of an action. For example, the computing system may instruct the robot to perform a subset of movements (e.g., one hand member movement of multiple hand member movements) and/or output a subset of audio (e.g., one audio phrase from multiple audio phrases) corresponding to an action. The computing system may determine that a partial output identifies a subset of the action. For example, the computing system may determine that a second computing system is in the process of providing the output to identify the action. In an effort to reduce latency, based on obtaining a partial output (e.g., from the second computing system) and determining that the partial output identifies a subset of the action, the computing system may instruct partial performance of the action (e.g., while the second computing system further provides or finishes providing the output). In some cases, the computing system may determine that an output is associated with a particular latency and may perform a subset of the action corresponding to a subset of the output to reduce the latency.

In some cases, the computing system may determine a result of instructing performance of the action (e.g., feedback). For example, the computing system may determine whether the action was performed (e.g., successfully performed, not performed, partially performed, etc.) and/or a manner in which the action was performed (e.g., how the action was performed). To determine whether the action was performed and/or how the action was performed, the computing system may obtain sensor data (e.g., sensor data associated with the robot). Based on the sensor data, the computing system may identify a status of the robot (e.g., a battery status), a location of the robot, one or more movements of the robot, audio output by the robot, images displayed by the robot, audio input (e.g., audio input from an entity), image data captured by an image sensor, etc. For example, the computing system may identify that the robot is stuck or lost in the site based on the sensor data. In another example, the action may include an audio action to ask an entity a question and perform a second action based on the response of the entity. Based on determining whether audio corresponding to the audio action was output by the robot, whether an audible, visual, or physical response was received by the robot from the entity, and whether a corresponding second action was performed, the computing system may determine the result of instructing performance of the action.

The computing system may compare the identified status, the location, the one or more movements, the audio output, the images, audio input, the captured image data, etc. to an action. For example, the system may compare the identified status, the location, the one or more movements, the audio output, the images, the audio input, the captured image data, etc. to the action identified based on the output of the computing system. In another example, the system may compare the identified status, the location, the one or more movements, the audio output, the images, the audio input, the captured image data, etc. to an action associated with an action identifier (e.g., provided by a user computing device).

Based on comparing the identified one or more movements, the audio output, the images, etc. to the action, the computing system may determine whether the action was performed and/or how the action was performed.

The computing system may determine that the action was not performed by the robot. For example, the action may be an action to guide an entity to a destination (e.g., a particular room). Based on the sensor data, the computing system may determine that the robot did not perform the action (e.g., based on the legs of the robot not moving, based on the location of the robot not corresponding to the particular room during a particular time period, based on determining that the robot is stuck or lost, based on an entity indicating that the action was not performed, etc.). In some cases, the robot may provide an input to the computing system indicating that the action was not performed. For example, the robot may provide an input to the computing system indicating that the robot was not able to and/or did not perform the action and/or a reason for not performing the task (e.g., the robot is stuck, the battery of the robot is depleted, one of the legs of the robot is damaged, etc.).

The computing system may determine that the action was performed by the robot. For example, the action may be an action to guide an entity to a destination (e.g., a particular room). Based on the sensor data, the computing system may determine that the robot did perform the action (e.g., based on the legs of the robot moving in a predicted manner and/or for a predicted duration, based on the location of the robot corresponding to the particular room during a particular time period, based on an entity indicating that the action was performed, etc.). In some cases, the robot may provide an input to the computing system indicating that the action was performed. For example, the robot may provide an input to the computing system indicating that the robot was able to and/or did perform the action.

In some cases, the computing system may determine a manner in which the action is performed (e.g., using the senor data). Further, the computing system may determine whether the manner in which the action is performed deviates from the manner in which the computing system expected or requested that the robot perform the action. For example, the action may be an action to guide an entity to a destination (e.g., a particular room) and the action may include a request to navigate the entity via a first route. Based on the sensor data, the computing system may determine that the robot did perform the action (e.g., guide the entity to the destination), however, the computing system may determine that the robot utilized a different manner of performing the action (e.g., the robot navigated the entity to the destination using a second route instead of the first route). In some cases, the computing system may determine why the performed action deviated from the manner in which the computing system expected or requested that the robot perform the action. For example, based on the sensor data, the computing system may determine that the performed action deviated from the manner in which the computing system expected or requested that the robot perform the action because of an object, obstacle, structure, or entity in the site (e.g., blocking the first route), because the entity refused to follow the first route, etc.

Based on determining a result of instructing performance of the action (e.g., whether the action was performed, a manner of performing the action, etc.), the computing system may adjust how subsequent actions are determined and/or performed. For example, in response to obtaining prompt data that includes an action identifier of the action (e.g., an entity requesting performance of the same or a different action), the computing system may provide the result of previously instructing performance of the action, the prompt data, and the transformed data (e.g., semantic tokens, comments, etc.) to the computing system (e.g., the second computing system). The computing system may provide the results of previously instructing performance of the action, the prompt data, and the transformed data to a machine learning model to generate an output. In another example, the computing system may train the machine learning model based on the results of previously instructing performance of the action, the prompt data, and the transformed data. As discussed above, the computing system may identify an action based on an output of the computing system.

In some cases, different personas may be associated with different actions. For example, the computing system may identify a first input indicative of a first persona (e.g., during a first time period). The first persona may be associated with a first set of audio characteristics (e.g., a first pitch, a first accent, a first pace, a first volume, a first rate, a first rhythm, a first articulation, a first pronunciation, a first annunciation, a first tone, a first background, a first language (e.g., English, French, Spanish, etc.), a first gender, and/or a first fluency). The computing system may instruct performance of one or more first actions in accordance with the first persona. Subsequently, the computing system may identify a second input indicative of a second persona (e.g., during a second time period). The second persona may be associated with a second set of audio characteristics (e.g., a second pitch, a second accent, a second pace, a second volume, a second rate, a second rhythm, a second articulation, a second pronunciation, a second annunciation, a second tone, a second background, a second language, a second gender, and/or a second fluency). The computing system may instruct performance of one or more second actions in accordance with the second persona.

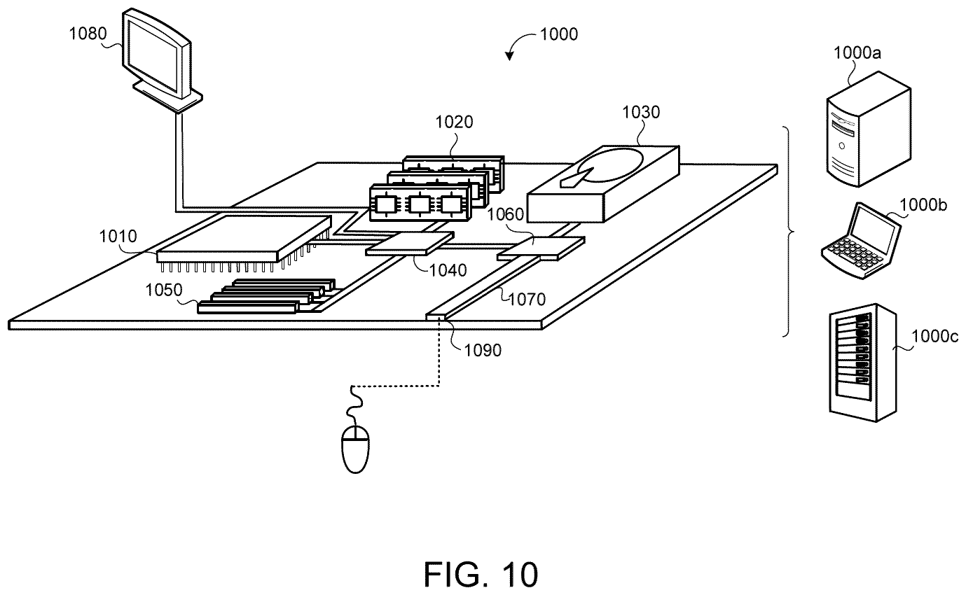

FIG. 10 is a schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020 (e.g., non-transitory memory), a storage device 1030, a high-speed interface/controller 1040 connecting to the memory 1020 and high-speed expansion ports 1050, and a low-speed interface/controller 1060 connecting to a low-speed bus 1070 and a storage device 1030. All or a portion of the components of the computing device 1000 may be interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to the high-speed interface/controller 1040. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium, a volatile memory unit(s), or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high-speed interface/controller 1040 manages bandwidth-intensive operations for the computing device 1000, while the low-speed interface/controller 1060 manages lower bandwidth-intensive operations. Such allocation of duties is exemplary only. In some implementations, the high-speed interface/controller 1040 is coupled to the memory 1020, the display 1080 (e.g., through a graphics processor or accelerator), and to the high-speed expansion ports 1050, which may accept various expansion cards (not shown). In some implementations, the low-speed interface/controller 1060 is coupled to the storage device 1030 and a low-speed expansion port 1090. The low-speed expansion port 1090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a (or multiple times in a group of such servers), as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
obtaining, by data processing hardware of a mobile robot, a site model associated with a site and in a first data format;
obtaining, by the data processing hardware, sensor data in a second data format;
transforming, by the data processing hardware, the site model from the first data format to a text data format to obtain a transformed site model;
transforming, by the data processing hardware, the sensor data from the second data format to the text data format to obtain transformed sensor data;
obtaining, by the data processing hardware, transformed data in the text data format based on the transformed site model and the transformed sensor data;
providing, by the data processing hardware, the transformed data to a computing system;
identifying, by the data processing hardware, an action based on an output of the computing system in response to providing the transformed data to the computing system; and
instructing, by the data processing hardware, performance of the action by the mobile robot.

2. The method of claim 1, further comprising:
obtaining prompt data according to a programming language; and
providing the prompt data to the computing system,
wherein transforming the site model and the sensor data comprises:
generating the transformed data according to one or more of a syntax of the programming language or semantics of the programming language, wherein the transformed data comprises one or more semantic tokens according to the programming language, and wherein the output of the computing system is based on the one or more semantic tokens.

3. The method of claim 1, wherein transforming the site model and the sensor data comprises:
generating the transformed data, wherein the transformed data comprises one or more semantic tokens according to a programming language, wherein the one or more semantic tokens comprise at least one of:
one or more operators based on a library associated with the programming language,
one or more functions based on the library, or
one or more keywords based on the library.

4. The method of claim 1, wherein transforming the site model and the sensor data comprises:
generating the transformed data according to a Python programming language.

5. The method of claim 1, wherein the first data format and the second data format are different data formats.

6. The method of claim 1, further comprising:
obtaining prompt data, wherein the prompt data comprises one or more comments according to a programming language; and
providing the prompt data to the computing system, wherein the output of the computing system is based on the prompt data,
wherein transforming the site model and the sensor data comprises:
generating the transformed data, wherein the transformed data comprises one or more first semantic tokens according to the programming language,
wherein the computing system processes the one or more first semantic tokens and the one or more comments to generate one or more second semantic tokens, and
wherein the output is based on the one or more second semantic tokens.

7. The method of claim 1, further comprising identifying a persona of the mobile robot, wherein the action is based on the persona of the mobile robot, and wherein the persona of the mobile robot comprises a time period based persona, a location based persona, an entity based persona, or an emotion based persona.

8. The method of claim 1, further comprising:
instructing display of a user interface, wherein the user interface provides a plurality of personas of the mobile robot for selection; and
obtaining a selection of a persona of the mobile robot of the plurality of personas of the mobile robot, wherein the action is based on the persona of the mobile robot.

9. The method of claim 1, further comprising identifying a persona of the mobile robot, wherein the action is based on the persona of the mobile robot, and wherein the persona of the mobile robot is indicative of at least one of a character description, a character goal, or a character phrase.

10. The method of claim 1, further comprising:
obtaining audio data;
providing the audio data to a second computing system;
obtaining transformed audio data based on providing the audio data to the second computing system; and
identifying a portion of the transformed audio data corresponds to a particular phrase, wherein one or more of obtaining the sensor data or transforming the site model and the sensor data is based on identifying the portion of the transformed audio data corresponds to the particular phrase.

11. The method of claim 1, further comprising:
obtaining audio data;
providing the audio data to a second computing system;
obtaining transformed audio data based on providing the audio data to the second computing system;
identifying a portion of the transformed audio data corresponds to a particular phrase; and
instructing performance of one or more actions by the mobile robot to be paused based on identifying the portion of the transformed audio data corresponds to the particular phrase.

12. The method of claim 1, further comprising:
obtaining first audio data;
identifying second audio output by the mobile robot; and
suppressing the second audio output by the mobile robot based on the first audio data.

13. The method of claim 1, wherein the action is indicative of at least one of audio data or a movement of the mobile robot, and wherein instructing performance of the action comprises one or more of:
instructing output of the audio data by the mobile robot; or
instructing the mobile robot to move according to the movement.

14. The method of claim 1, further comprising:
obtaining first audio data;
assigning an identifier to an entity based on the first audio data, wherein the action is indicative of second audio data, wherein the second audio data is based on the identifier; and
instructing output of the second audio data by the mobile robot.

15. The method of claim 1, wherein the action is indicative of audio data and a movement of the mobile robot, wherein instructing performance of the action comprises:
determining an entity within an environment of the mobile robot, wherein the audio data is based on the entity;
instructing performance of the movement by the mobile robot such that the mobile robot is oriented in a direction towards the entity; and
instructing output of the audio data by the mobile robot.

16. The method of claim 1, wherein the action is indicative of audio data and a movement of the mobile robot, wherein instructing performance of the action comprises:
determining an entity within an environment of the mobile robot, wherein the audio data is based on the entity; and
instructing simultaneous performance of the movement and output of the audio data by the mobile robot.

17. The method of claim 1, further comprising:
determining a result of instructing performance of the action;
obtaining a second site model associated with a second site and in the first data format;
obtaining second sensor data in the second data format;
transforming the second site model and the second sensor data to generate second transformed data in the text data format;
providing the second transformed data and the result of instructing performance of the action to the computing system;
identifying a second action based on a second output of the computing system in response to providing the transformed data and the result of instructing performance of the action to the computing system; and
instructing performance of the second action by the mobile robot.

18. The method of claim 1, wherein obtaining the sensor data comprises obtaining the sensor data from a first data source, and wherein obtaining the site model comprises obtaining the site model from a second data source that is different as compared to the first data source.

19. A system comprising:
data processing hardware; and
memory in communication with the data processing hardware, the memory storing instructions, wherein execution of the instructions by the data processing hardware, causes the data processing hardware to:
obtain a site model associated with a site and in a first data format;
obtain, by at least one sensor, sensor data in a second data format;
transform the site model from the first data format to a text data format to obtain a transformed site model;
transform the sensor data from the second data format to the text data format to obtain transformed sensor data;
obtain transformed data in the text data format based on the transformed site model and the transformed sensor data;
provide the transformed data to a computing system;
identify an action based on an output of the computing system in response to providing the transformed data to the computing system; and
instruct performance of the action by a mobile robot.

20. The system of claim 19, wherein to provide the transformed data to the computing system, the execution of the instructions by the data processing hardware, further causes the data processing hardware to:
provide the transformed data to a machine learning model, wherein the machine learning model is implemented by at least one of the data processing hardware or a remote computing system.

21. The system of claim 19, wherein the execution of the instructions by the data processing hardware, further causes the data processing hardware to:
determine a second action performed by the mobile robot based on instructing performance of the action;
identify a third action based on providing second transformed data, an identifier of the second action, the sensor data, and the site model to the computing system; and
instruct performance of the third action by the mobile robot.

22. The system of claim 19, wherein to provide the transformed data to the computing system, the execution of the instructions by the data processing hardware, further causes the data processing hardware to:
provide the sensor data for annotation; and
obtain annotated sensor data based on providing the sensor data for annotation,
wherein to transform the site model and the sensor data, the execution of the instructions by the data processing hardware, further causes the data processing hardware to:
transform the site model and the annotated sensor data.

23. The system of claim 19, wherein to provide the transformed data to the computing system, the execution of the instructions by the data processing hardware, further causes the data processing hardware to:
collate the transformed site model and the transformed sensor data to generate the transformed data.

24. A robot comprising:
at least one sensor;
data processing hardware in communication with the at least one sensor; and
memory in communication with the data processing hardware, the memory storing instructions, wherein execution of the instructions by the data processing hardware, causes the data processing hardware to:
obtain a site model associated with a site and in a first data format;
obtain, by the at least one sensor, sensor data in a second data format;
transform the site model from the first data format to a text data format to obtain a transformed site model;
transform the sensor data from the second data format to the text data format to obtain transformed sensor data;
obtain transformed data in the text data format based on the transformed site model and the transformed sensor data;
provide the transformed data to a computing system;
identify an action based on an output of the computing system in response to providing the transformed data to the computing system; and
instruct performance of the action by the robot.

25. The robot of claim 24, wherein the site model comprises an annotated site model, and wherein the annotated site model comprises one or more semantic labels associated with one or more objects in the site.

26. The robot of claim 24, wherein the site model comprises a virtual representation of one or more of a blueprint, a map, a computer-aided design (“CAD”) model, a floor plan, a facilities representation, a geo-spatial map, or a graph.

27. The robot of claim 24, wherein the sensor data comprises at least one of:
orientation data;
image data;
point cloud data;
position data;
time data;
audio data; or
annotated sensor data, wherein the annotated sensor data comprises one or more captions associated with the sensor data.

28. The robot of claim 24, wherein execution of the instructions by the data processing hardware, further causes the data processing hardware to:
instruct display of a user interface, wherein the user interface provides a plurality of action identifiers of the robot for selection; and
obtain a selection of an action identifier of the plurality of action identifiers, wherein the action is based on the action identifier.
